(19) United States
(12) Patent Application Publication
(10) Pub. No.: US 2002/0022928 A1
(43) Pub. Date: Feb. 21, 2002

(54) System and method for providing profit analysis for site-specific farming

(75) Inventor: Todd Ell, Savage, MN (US)

Correspondence Address: David R. Fairbairn, THE KINNEY & LANGE BUILDING, 312 South Third Street, Minneapolis, MN, 55415-1002, US

(73) Assignee: AGCO

(21) Appl. No.: 09/874,915

(22) Filed: Jun. 5, 2001

Related U.S. Application Data
(60) Provisional application No. 60/209,380, filed on Jun. 5, 2000.

(51) Int. Cl. G01V 3/00; G01V 7/00; G06F 19/00

(52) U.S. Cl. 702/2

(57) ABSTRACT

The present invention is a system and method for providing profit analysis for site-specific farming. The present invention uses two different methods to analyzes and compare applications of agricultural products. The first method compares the potential for yield increases in nutrient-limited areas. The second method compares the potential for cost savings of fertilizer in areas with high quality soil. The applications may be site-specific or whole-field applications. The present invention uses soil fertility information to calculate and compare the results of various applications.

### CROSS-REFERENCE TO RELATED APPLICATION(S)

Cross-reference to the following applications: System and Method for Creating Field Attribute Maps for Site-Specific Farming, Ser. No. ______; System and Method for Creating Crop Input Requirement Maps for Site-Specific Farming, Ser. No. ______; System and Method for Creating Demo Application Maps for Site-Specific Farming, Ser. No. ______; System and Method for Creating Controller Application Maps for Site-Specific Farming, Ser. No. ______; System and Method for Creating Application Maps for Site-Specific Farming, Ser. No. ______; and System and Method for Analyzing Data Contained in a Computerized Database, Ser. No. ______. The above applications are filed on even date with this application and are assigned to AGCO Corporation, the same assignee as the present invention.

### BACKGROUND OF THE INVENTION

The present invention relates to the application of agricultural products. More specifically, the present invention is a system and method of creating an application map for applying agricultural products to field.

The management of crop production can be enhanced by taking into account spatial variations that exist within a given agricultural field. By varying the products applied across a field, crop yields can be improved and the environmental impact more closely controlled. The variation of agricultural products is commonly referred to as site-specific farming.

Site-specific farming involves the collection and processing of data relating to the agronomic characteristics of a field. Agronomic data is collected for specific field locations that may vary in size. The specific field locations are combined into a map that covers an entire field.

The information collected for each field location is used to determine the crop inputs to apply to each location. The information is combined with pre-defined and user-defined recommendation equations and product information to determine the blend of agricultural products required for a specific location. Once the products are determined for each location in a field, an application map is created for the entire field.

A control system reads the information from the application map and generates control signals for various applicators on an agricultural vehicle. The agricultural vehicle is designed to vary the application of crop inputs, thus the agricultural vehicle will adjust the application of crop inputs as it traverses a field based on the application map.

Currently the process of creating application maps requires each step of the process to be repeated each time a new map is created. In addition, mapping software limits the type of recommendation equations and product information that can be used. A more flexible mapping process and system are needed. The process needs to be broken into steps or sub-parts so that only the relevant steps are repeated each time a new map is created. The mapping system needs a more flexible way of handling various data types so that the user can enter various formats of recommendation equations or product information. In addition, a more efficient and flexible method of blending crop inputs is needed.

### BRIEF SUMMARY OF THE INVENTION

The present invention is a system and method for providing profit analysis for site-specific farming. The present invention uses two different methods to analyze and compare applications of agricultural products. The first method compares the potential for yield increases in nutrient-limited areas. The second method compares the potential for cost savings of fertilizer in areas with high quality soil.

The applications may be site-specific or whole-field applications. A site-specific application can be analyzed and compared to a whole-field application to show a user the benefits of a site-specific application over a whole-field application. A site-specific application may also be compared to another site-specific application to help a user determine which site-specific application is the most beneficial. The present invention uses soil fertility information to calculate and compare results of the various applications.

### BRIEF DESCRIPTION OF THE DRAWINGS

FIG. 1 is a block diagram illustrating the operation of a site-specific farming system.

FIG. 2 is a block diagram illustrating the software components of a Field Data Collection System and Harvest Data Collection System.

FIG. 3 is a block diagram illustrating the software components of an Application Control System.

FIG. 4 is a block diagram illustrating the software components of a Mapping Software program.

FIG. 5 is a block diagram illustrating the software components of a Data Validation System.

FIG. 6 is a block diagram illustrating the software components of a Prescription Mapping System.

FIG. 7 is a flow diagram illustrating the creation of an application map.

FIG. 8 is a block diagram illustrating the software components of a Customer Data Management System.

FIG. 9 is a block diagram illustrating the software components of a Product-Prescription Management System.

FIG. 10 is a block diagram illustrating the software components of a Planning System.

FIG. 11 is a block diagram illustrating the software components of a Spatial Data Management System.

FIG. 12 is a block diagram illustrating the software components of a Data Transfer System.

FIG. 13 is a block diagram illustrating the software components of a Base Data Management System.

FIG. 14 is a block diagram illustrating the software components of a User Preference System.

FIG. 15 is a block diagram illustrating the software components of a Decision Support & Analysis System.

FIG. 16 is a block diagram illustrating the software components of a Map Charging System.

FIG. 17 is a software interface illustrating the components used to create Agronomic Prescription Maps based on Recommendation Equations and Agronomic Inputs.

FIG. 18 is a software interface illustrating the components used to create a Recommendation Equation file.

FIG. 19 is a software interface illustrating the components used to view the details of a Recommendation Equation file.

FIG. 20 is a software interface illustrating the components used to create Recommendation Equations.

FIG. 21 is a block diagram illustrating the components of a Recommendation Equation Module.

FIG. 22 is a software interface illustrating the components used to create Demo Application Map based on Product Information.

FIG. 23 is a software interface illustrating the components used to view the details of Product Information.

FIG. 24 is a flow diagram illustrating the creation of Demo Application Maps.

FIG. 25 is a block diagram illustrating the components of Mapping Software Inputs and a Spatial Blending Module.

FIG. 26 is a flow diagram illustrating the components of a Spatial Blending Engine.

FIG. 27 is a software interface illustrating the components used to create a controller application map.

FIG. 28 is a flow diagram illustrating the creation of Controller Application Maps.

### DETAILED DESCRIPTION

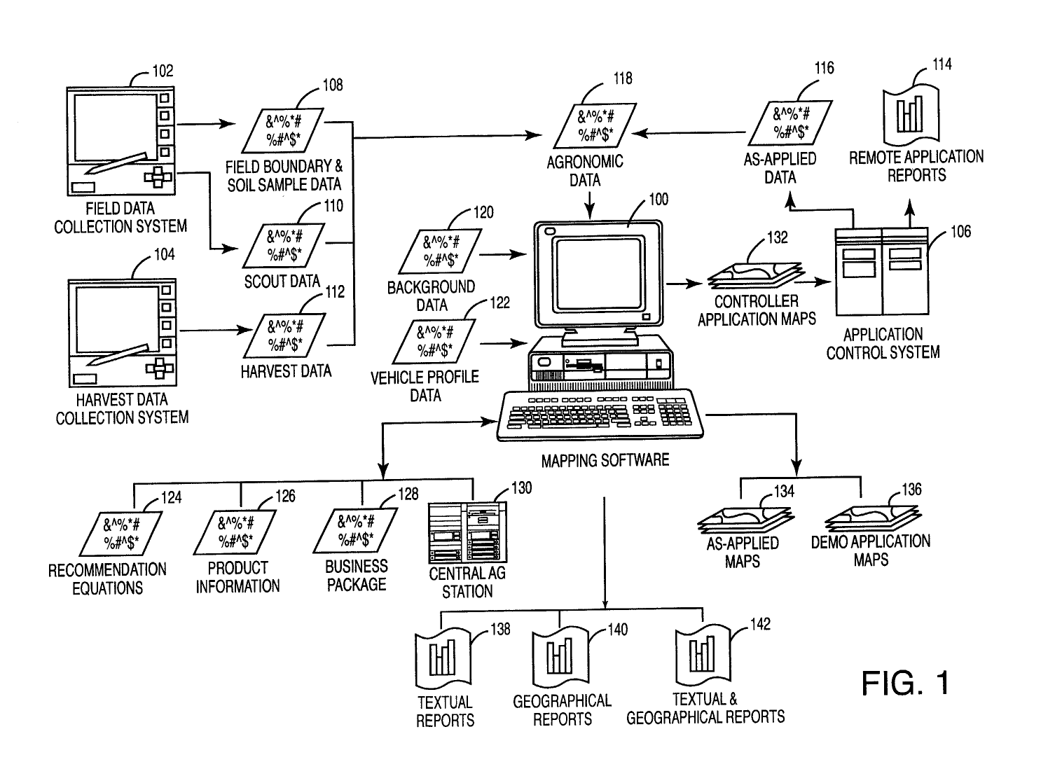

### 1. Site-specific Farming System (FIG. 1)

The main components of a site-specific farming system are shown in FIG. 1. Each component is briefly described in this section and then explained in further detail in the following sections. Mapping Software 100, Field Data Collection System 102, Harvest Data Collection System 104, and Application Control System 106 represent the major components of a site-specific farming system. Field Data Collection System 102 and Harvest Data Collection System 104 collect agricultural information in the field, Mapping Software 100 processes the information on a computer and creates an application map, and Application Control System 106 is located on an application machine in the field and uses the application map to apply crop inputs to the field.

The outputs of Field Data Collection System 102 are Field Boundary & Soil Sample Data 108 and Scout Data 110. The output of Harvest Data Collection System 104 is Harvest Data 112, and the outputs of Application Control System 106 are Remote Application Reports 114 and As-Applied Data 116. The outputs of Field Data Collection System 102, Harvest Data Collection System 104, and Application Control System 106 are input to Mapping Software 100 as Agronomic Data 118. The other inputs to Mapping Software 100 are Background Data 120 and Vehicle Profile Data 122. Data is both input to and output from Recommendation Equations 124, Product Information 126, Business Packages 128, and Central Agricultural Station 130. The outputs of Mapping Software 100 are Controller Application Maps 132, As-Applied Maps 134, Demo Application Maps 136, Textual Reports 138, Geographical Reports 140, and Textual & Geographical Reports 142.

Mapping Software 100 converts Agronomic Data 118 into geographically-referenced maps that are used by Application Control System 106 to apply agricultural products to a field. Agricultural products include, but are not limited to, seeds, fertilizers (including micronutrients), pesticides (including insecticides, herbicides, fungicides), and any other soil amendment or addition of any kind used to facilitate crop growth. Agricultural products usually contain a combination of two or more crop inputs, such as 30% of one crop input and 70% of a second crop input. Crop inputs are the raw ingredients or chemicals needed for a particular field, such as nitrogen, phosphorous, and potassium. To obtain the required amount of crop inputs needed for a field, a blend or prescription of agricultural products is created by Mapping Software 100.

Mapping Software 100 may not be able to completely satisfy the crop input requirements for a particular field, but a user can guide Mapping Software 100 to find the most optimal blend of agricultural products for a particular field. The result is that the crop inputs needed for a field are satisfied by applying a blend of agricultural products containing the required crop inputs. Technically, crop inputs are applied to a field using a blend of agricultural products. Thus, the terms “crop inputs” and “agricultural products” may be used interchangeably when referring to the ingredients being applied to a field. The terms are distinguishable, however, in that “crop inputs” refers to the raw ingredients and “agricultural products” refers to the commercially available products that contain a mixture or combination of “crop inputs.”

Mapping Software 100 is stored on a computer, usually located in an office off-site from the targeted field, and uses the computer's processor to run various program modules contained in Mapping Software 100. A software user, such as an agronomist, farmer, technician, sales manager, agricultural retailer, etc. interacts with the various program modules of Mapping Software 100 to create the maps, referred to as Controller Application Maps 132 in FIG. 1. Once Controller Application Maps 132 have been created, they are transferred to Application Control System 106.

Field Data Collection System 102 is responsible for collecting and storing agricultural data. Agricultural data can be either imported or input by a user. Agricultural data includes, but is not limited to, soil test results, soil surveys, field boundaries, and scouting information. Field Boundary & Soil Sample Data 108 and Scout Data 110 are the outputs of Field Data Collection System 102. Field Boundary & Soil Sample Data 108 contains information related to soil sampling and field boundaries. Scout Data 110 consists of information related to scouting crops and weeds. Field Data Collection System 102 supports a number of data import formats, such as ESRI shape files, comma separated variable (CSV) format, ASCII files, and soil sample data files.

Harvest Data Collection System 104 collects information related to the harvest of crops from a field, specifically the yield data. The information can be input by a user or imported from a yield collection system located on a harvest machine. Information input from a user is typically whole-field information. Whole-field information contains a yield for the entire field. Information from a yield collection system typically contains site-specific information. Site-specific information contains a yield for each pre-defined section of the field.

Application Control System 106 is control hardware located on an application machine or application machine operated in a field. Application Control System 106 may be the Falcon Controller, manufactured by Ag Chem Equipment Co., or any third party controller. Controller Application Maps 132 are the input for Application Control System 106. The transfer of information from Mapping Software 100 to Application Control System 106 requires manual or electronic transportation of Controller Application Maps 132 to Application Control System 106. The transfer of information is usually accomplished with a data storage medium, such as a disk, but other methods such as modem data transfer can be used. Controller Application Maps 132 are delivered to the application machine and are loaded into the memory of Application Control System 106.

Application Control System 106 controls the application of commercial agricultural products to a targeted field. More than one map may be generated for a targeted field to account for the numerous agricultural products that can be applied to a field, such as seed, fertilizer, and herbicides. The maps can be stacked and used to apply multiple products simultaneously or they may be used separately to apply individual products during separate passes across the field.

Application Control System 106 is responsible for controlling various sensors and actuators on the application machine. The instructions used by Application Control System 106 come from the code contained in Controller Application Maps 132. As the application machine traverses the field, the code generated by Controller Application Maps 132 sends instructions to Application Control System 106 to turn on sensors or actuators at specific points in the field. The specific points are determined by a position locator, such as a dead-reckoning system or Global Positioning System (GPS). In addition to controlling the application of crop inputs, Application Control System 106 collects As-Applied Data 116, which provides information about the agricultural products applied to a filed. This information is fed back into Mapping Software 100 and used to create Controller Application Maps 132. Application Control System 106 also creates Remote Application Reports 114, which provide on-site reports of the products applied to a field.

Field Boundary & Soil Sample Data 108 refers to the boundary and soil make-up of a field. Once the boundary of a field is established, numerous soil samples are collected throughout the field. The soil information may be input directly to Mapping Software 100 or sent to a lab for evaluation and then input into Mapping Software 100. The boundary and soil sample information is used to create a soil map broken into a grid or sub-parts based on soil content. The soil map is used by Mapping Software 100 to create Controller Application Maps 132.

Scout Data 110 contains information either collected by a person who walks a field or obtained from aerial photos of a field. A person scouting a field looks for certain weeds, crop damage, etc. and records this information for future use. Aerial photos of a field can also produce scouting information. Aerial photos use a spectrum of color from a photo and soil samples to determine the soil content of a field. Scouting information includes, but is not limited to, condition of the crops, classification of weeds in the field, classification of insects in the field, the effects of weather conditions, etc. The information is sent to Mapping Software 100 and used to create Controller Application Maps 132.

Harvest Data 112 is the information collected during the harvest of crops from a field. The data can be either imported directly into Mapping Software 100 or entered by hand. The format of the information will vary based on the vehicle used to collect the information. The information may be for the entire field or broken down by pre-determined sections, such as the yield for the entire field or the yield for each section of the field.

Remote Application Reports 114 are reports generated by Application Control System 106. The reports are generated in the field and provide information on the crop inputs applied to a field. The reports provide immediate feedback that can be used by a variety of people, specifically the application machine operator and the farmer who owns the field.

As-Applied Data 116 includes the information collected by Application Control System 106 during application of crop inputs to a field. For example, As-Applied Data 116 records the actual speed of the application machine and the delivery rate of the agricultural products. As-Applied Data 116 also includes customer data, field data, weather conditions, etc. As-Applied Data 116 is transferred to Mapping Software 100 using an electric magnetic or optical storage medium. As-Applied Data 116 is used to generate reports and to create future maps with Mapping Software 100.

Agronomic Data 118 is input to Mapping Software 100 and represents the agricultural and harvest information related to a field. As explained previously, Agronomic Data 118 includes, but is not limited to, soil test results, soil surveys, field boundaries, scouting information and yield data. Agronomic Data 118 can be collected either automatically or manually. Any data points related to a field, whether soil tests, scouting information, weather, etc. are considered Agronomic Data 118 and are used by Mapping Software 100.

Background Data 120 contains township, boundary, and soil data for the majority of the U.S. Background Data 120 is agricultural information obtained by the government and made available to the public by governmental agencies.

Vehicle Profile Data 122 includes data relating to the vehicle constraints of the application machine applying the crop inputs. Application machines have different capabilities and cannot deliver every possible product at every possible rate. The mechanical capabilities of an application machine are input to Mapping Software 100 and used to create Controller Application Maps 132. Vehicle Profile Data 122 may be directly input to Mapping Software 100 or transferred on a disk or other portable storage medium.

Recommendation Equations 124 are equations that define the prescription of crop inputs needed for a specific field location. Recommendation Equations 124 are either pre-defined or user-defined. Pre-defined equations are part of Mapping Software 100. User-defined equations can either be imported or manually entered by a user. Recommendation Equations 124 may also be exported and used by another mapping software system.

Product Information 126 contains the crop input breakdown for each product used by Controller Application Maps 132. For example, a commercial product, such as a fertilizer, may contain 40% phosphorous, 40% potassium, and 20% nitrogen. The breakdown of each products is used by Mapping Software 100 to determine which products and the amount of each product to use at specific points in a field. Product Information 126 can be automatically imported or manually entered into Mapping Software 100.

Business Packages 128 exchanges information with third party business and accounting software. Information created by Mapping Software 100 can be directly imported by third-party software. Likewise, data created by third-party software packages can be imported to Mapping Software 100.

Central Agricultural Station 130 provides remote technical support for Mapping Software 100 by allowing remote access to Controller Application Maps 132 and the data used to create Controller Application Maps 132. The remote technical support helps users create maps, understand the information in a map, or troubleshoot technical problems with Mapping Software 100.

Controller Application Maps 132, as explained above, contain the code used by Application Control System 106 to apply agricultural products to a field. Controller Application Maps 132 may contain one map, for applying one product, or multilayer maps, for applying multiple products. The products may be applied in one pass or multiple passes across the field, depending on the capabilities of the application machine or the preference of the user.

As-Applied Maps 134 are maps of the crop inputs applied to a field. For various reasons, the crop inputs applied to a field may not exactly match the crop inputs defined by Controller Application Maps 132. Therefore, As-Applied Maps 134 creates a history of the crop inputs applied to a field.

Demo Application Maps 136 are application maps that can only be viewed by a user. In other words, the user can view the maps on a computer monitor or print the maps for viewing purposes, but the maps cannot be used to apply products to a field. This allows the user to decide if the maps are acceptable before paying the fee required to convert the maps into code that can be used by Application Control System 106.

Textual Reports 138 are statistical reports for various aspects of the map making process. Geographical Reports 140 are graphical reports showing agriculture information based on a visual key, such as colors or cross-hatching. Textual and Geographical Reports 142 are reports containing both statistical and graphical information. The reports include, but are not limited to, field location, crop regions, corn yield goals, soil test pH, soil test pH by soil type, crop input recommendations, product summary, application costs, etc.

As explained previously, Mapping Software 100 includes a number of different program modules. These program modules reference the inputs and outputs represented in FIG. 1 and explained above. All of the inputs are not required by each program module; therefore, information is not required from every input in order to generate Controller Application Maps 132. As the various program modules are described, the inputs referenced by the program module will be discussed in further detail.

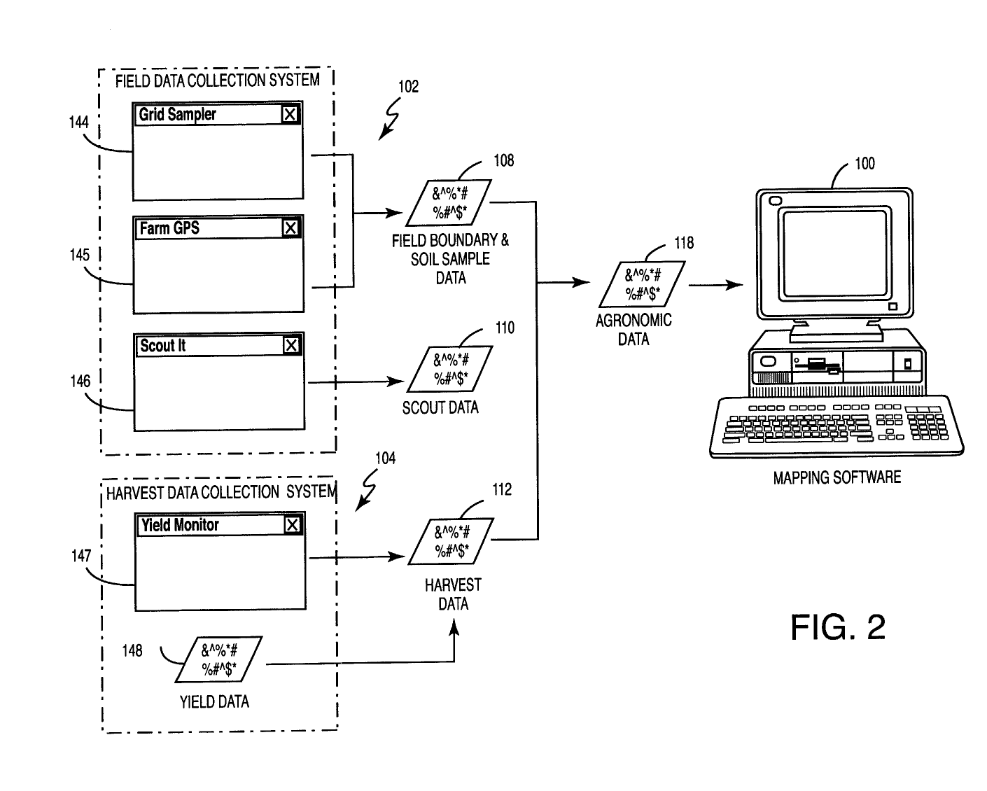

2. Field Data Collection System 102 and Harvest Data Collection System 104 (FIG. 2)

Field Data Collection System 102 and Harvest Data Collection System 104 are shown in FIG. 2. Field Data Collection System 102 contains a number of software interface modules. The software interface modules shown in FIG. 2 and subsequent figures are represented by a box with a title block containing an “x” in the upper right hand corner. Software interface modules are software programs that contain a user interface. The user interface allows a user to interact with the software, including inputting information and receiving data. The data received from the software interface may be viewed on a computer screen or sent to a printer or storage medium.

The software interface modules of Field Data Collection System 102 include Grid Sampler 144, Farm GPS System 145, and Scout It 146. The outputs of Field Data Collection System are Field Boundary & Soil Sample Data 108 and Scout Data 110, which are sent to Mapping Software 100 as Agronomic Data 118.

Grid Sampler 144 and Farm GPS System 145 work together to establish the boundary and soil samples of a targeted field. Farm GPS System 145 is generally located on a remote or portable computer. Farm GPS System 145 automatically records the perimeter of a field using a portable computer, which may be carried in a back-pak, on a four-wheeler, or with any type of transportation that can traverse the targeted field. The portable computer allows the user to enter meta data related to the field, such as the grower's name, the location of the field, etc.

Grid Sampler 144 uses the field boundaries collected by Farm GPS System 145 to plan out a soil sample strategy for the targeted field. For example, the user may program Grid Sampler 144 to break the field into 5 acre samples with a northern orientation. Grid Sampler 144 may be located in the field, where the soil samples are determined on-site, or it may be located off-site in an office, where the soil sample strategy would be calculated prior to collecting information from the field. Grid Sampler 144 can reuse the information from Farm GPS 145 each year to redefine the grid sampling of the field. Once the grid sampling is established, Farm GPS 145 collects the soil sample location for each grid and labels the sample according to the grid location. The sampling information is combined with the information from Farm GPS System 145 and referred to as Field Boundary & Soil Sample Data 108. Once the required information is collected and stored, Field Boundary & Soil Sample Data 108 is input to Mapping Software 100 as Agronomic Data 118.

Scout It 146 collects information relating to the conditions of the targeted field. The information includes the condition of the plants and the weeds found in the field. A crop scouter walks the field to collect the information. The information is entered manually, either in the field using a portable computer or with an office computer using hand-written notes collected in the field. The information collected is referred to as Scout Data 110, which is stored on a disk or other type of portable storage medium and transferred to Mapping Software 100 as Agronomic Data 118.

Harvest Data Collection System 104 contains Yield Monitor 147 and Yield Data 148. Yield Monitor 147 is an interface module and is used to collect site-specific yield information from a field. Yield Data 148 is whole-field information containing yield data for an entire field. The output of both Yield Monitor 147 and Yield Data 148 is Harvest Data 112. Harvest Data 112 is input to Mapping Software 100 as Agronomic Data 118.

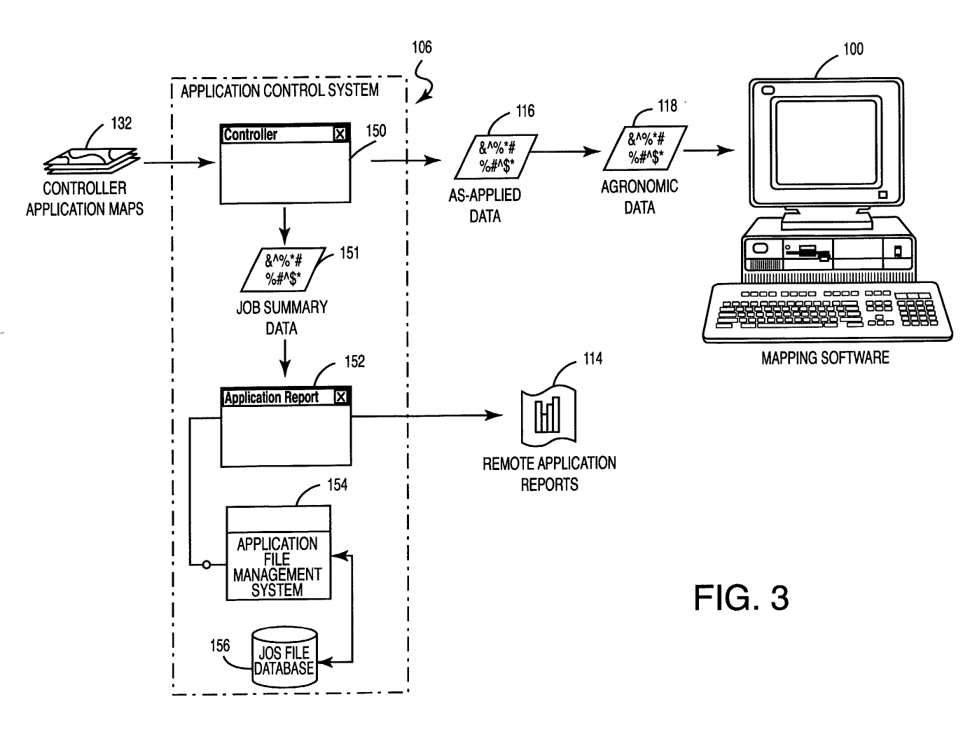

3. Application Control System 106 (FIG. 3)

The main components, inputs, and outputs of Application Control System 106 are shown in FIG. 3. Application Control System 106 is by itself an intricate control system, therefore, only the components relevant to the creation of Controller Application Maps 132 are shown and explained with respect to FIG. 3.

The software interface modules of Application Control System 106 are Controller 150 and Application Report 152. Application Control System 106 also includes a software module and a database. The software module in FIG. 3 and subsequent figures is represented by a square box with one horizontal line towards the top of the box. A software module provides internal processing of information that is used by a software interface module or stored in a database for future use. The database in FIG. 3 and subsequent figures is represented by a cylinder. The database organizes and stores information for later retrieval by the software module.

The input to Application Control System 106 is Controller Application Maps 132. The outputs from Application Control System 106 are As-Applied Data 116 and Remote Application Reports 114. As-Applied Data 116 is input to Mapping Software 100 as Agronomic Data 118. Remote Application Reports 114 are used in the field.

Controller 150 is a software interface module used by the operator in the field to apply crop inputs based on the instructions from Controller Application Maps 132. At the same time, Controller 150 collects As-Applied Data 116. As-Applied Data 116 is input to Mapping Software 100 and used to create future Controller Application Maps 132.

Application Report 152 is a software interface module that formats Job Summary Data 151 into reports and maps of the agricultural products applied to a field. Job Summary Data 151 includes, but is not limited to, job summary, as-applied data, and controller maps. The job summary file includes general application information such as the field boundary, start time, stop time, weather conditions, and the agricultural products used. The as-applied data contains a detailed recording of what products are applied at every microsecond. The controller map information is a record of the actual map used to apply the products to the field.

Application Report 152 uses the job summary and controller map information to provide a report of the agricultural products applied to a field. The report is formatted according to Environmental Protection Agency (EPA) guidelines so that it can be filed with the state regulatory agency. EPA guidelines currently do not require the rate of application across a field, only the total application for the field; thus Application Report 152 can generate a summary of the application in addition to a detailed report.

The reports generated by Application Report 152 are sent to Remote Application Reports 114, which is located in the field and provides a hard-copy of the information. Remote Application Reports 114 is located in the field because some states require a person applying controlled substances to hand the farmer a report on the substances before leaving the field. Remote Application Reports 114 gives the person applying the controlled substances the ability to use Job Summary Data 151 to print a report in the field.

Application File Management System 154 archives the various types of information imported from Job Summary Data 151 The detailed application information, job summary information, and application maps used by Application Control System 106 are stored in JOS File Database 156. Application Report 152 uses Application File Management System 154 and JOS File Database 156 to create reports in the field. Reports can also be generated in the office using As-Applied Data 116, which is transferred and stored in Mapping Software 100.

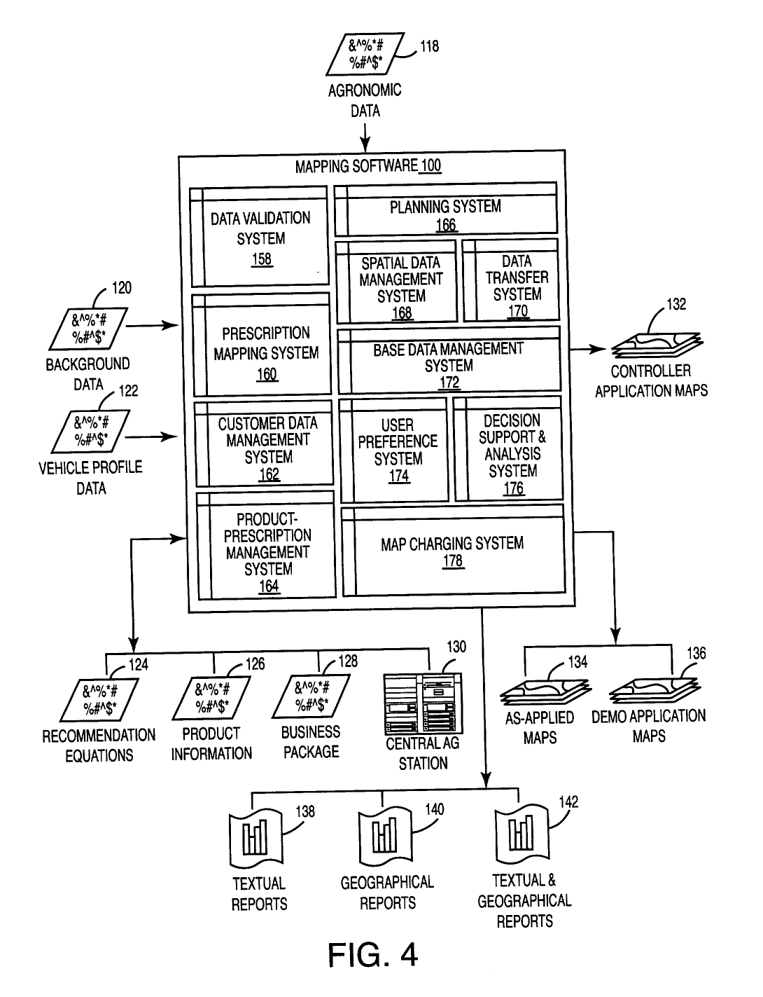

4. Mapping Software 100 (FIG. 4)

The main sub-programs of Mapping Software 100 are shown in FIG. 4 along with the inputs and outputs. The sub-programs shown in FIG. 4 and subsequent figures are represented by a rectangular box that contains two lines that cross in the upper left-hand corner. Each sub-program represents a unique action of Mapping Software 100 and contains its own interfaces and software modules.

Mapping Software 100 includes Data Validation System 158, Prescription Mapping System 160, Customer Data Management System 162, Product-Prescription Management System 164, Planning System 166, Spatial Data Management System 168, Data Transfer System 170, Base Data Management System 172, User Preference System 174, Decision Support & Analysis System 176, and Map Charging System 178.

Data Validation System 158 receives information from Field Data Collection System 102. The integrity of the data is verified by performing consistency and range checks. Each type of data, whether field boundary or yield data, has a unique system for checking the integrity of the data. If necessary, erroneous data is sent through a data cleansing process. Once the information has been validated or cleansed, it is stored in a database that is available to all the components of Mapping System 100. In addition, Data Validation System 158 uses As-Applied Data 116 to generate As-Applied Maps 134.

Prescription Mapping System 160 creates Demo Application Maps 136. As explained previously, Demo Application Maps 136 are maps that can be viewed but not used to apply agricultural products. Prescription Mapping System 160 is responsible for the first three steps towards the creation of Controller Application Maps 132. The first step is to create Field Attribute Maps. The second step creates Crop Input Requirement Maps. The third step is the creation of Demo Application Maps 136.

The data collected by Field Data Collection System 102 is converted into a standard format and combined to create Field Attribute Maps. The Field Attribute Maps are combined with Recommendation Equations 124 to develop the Crop Input Requirement Maps. The Crop Input Requirement Maps are maps containing the percentages of raw ingredients or crop inputs 1 needed for a field, such as potassium or nitrogen. Once the Crop Input Requirement Maps have been created, the information from Product Information 126 is used to change the percentages of crop inputs needed into a blend of agricultural products. The new map based on agricultural products is referred to as Demo Application Maps 136. Demo Application Maps 136 are converted to Controller Application Maps by using Map Charging System 178.

Prescription Mapping System 160 is aided by Customer Data Management System 162 and Product-Prescription Management System 164. Customer Data Management System 162 includes background information and a history of each field owned by a grower. Product-Prescription Management System 164 includes pre-defined recommendation equations and the crop input breakdown for numerous commercially-available agricultural products. In addition, Recommendation Equations 124 and Product Information 126 are input to and used by Product-Prescription Management System 164. The information available from Customer Data Management System 162 and Product-Prescription Management System 164 is stored in the main database of Mapping Software 100, which is in Spatial Data Management System 168.

Planning System 166 provides the main user-interface of Mapping System 100. Planning System 166 allows the user to access all the programs of Mapping Software 100 to create an application map for numerous fields. For example, if the user wants to define new crop zones for Field A, Planning System 166 gives the user access to a program module that redefines the zones for Field A. If the user wants to create a new map for Field B, Planning System 166 calls Prescription Mapping System 160 to create the map.

Spatial Data Management System 168 is responsible for the storage and handling of the data used by Mapping Software 100. Spatial Data Management System 168 stores both graphical and relational data. Each time information is entered or manipulated, it is stored in the database of Spatial Data Management System 168.

Data Transfer System 170 works with third-party business packages to automate the billing process. Information related to the cost of Controller Application Maps 132 can be directly imported into an existing accounting package and used by an agricultural retail center to bill a customer. Likewise, information contained in third-party business packages can be imported into Mapping Software 100 for use with Decision Support & Analysis System 176.

Base Data Management System 172 is responsible for organizing, storing, and retrieving information from Background Data 120. Base Data Management System 172 transforms the public information from Background Data 120 into a format that can be used by Mapping Software 100 to create Controller Application Maps 132.

User Preference System 174 is the main system that allows the user to predefine numerous features of Mapping Software 100. These features include, but are not limited to, user-interface set up, data storage, user reminders, units of measure, etc.

Decision Support & Analysis System 176 is a reporting and mapping package that allows the user to view information in numerous ways. The user can create a report with numerical soil test results for each cell of a grid or create a map with a graphical display of the soil test results. The user can also view a map that organizes the soil results by color. For example, soil rich in phosphorus can be shown in red; thus, the user can visually understand the soil make-up of a field. The user can also generate a report that provides a comparison of a flat-rate application of agricultural products with a variable-rate application. This allows the user to understand the financial advantages of site-specific farming.

Map Charging System 178 is responsible for tracking the costs of Controller Application Maps 132. Demo Application Maps 136 are transformed into Controller Application Maps 132 once the user has paid for the maps. If a map is not paid for, Application Control System 106 cannot access the map for the purpose of applying agricultural products to a field. If a user decides not to use a map that has been paid for, Map Charging System 178 allows the user to apply the costs towards the creation a new map. Thus, the user has great flexibility in the creation and use of Controller Application Maps 132.

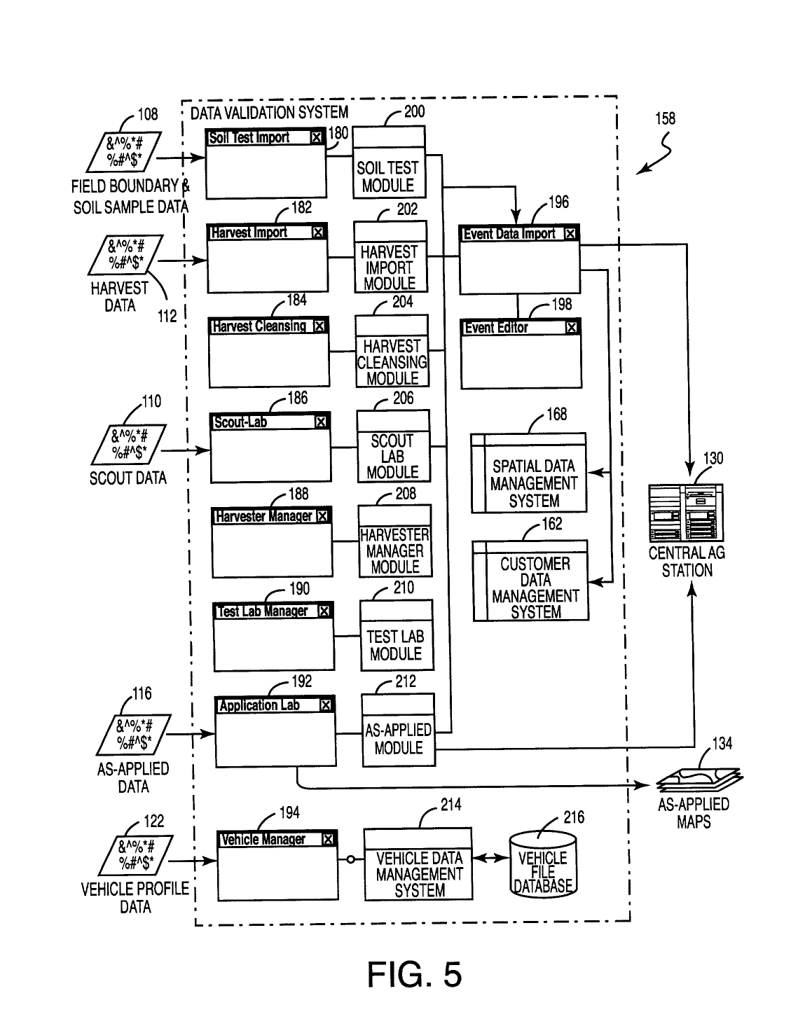

5. Data Validation System 158 (FIG. 5)

FIG. 5 shows the internal components of Data Validation System 158. In addition, the external inputs and outputs of Data Validation System 158 are shown in FIG. 5.

The software interface modules of Data Validation System 15 8 are Soil Test Import 180, Harvest Import 182, Harvest Cleansing 184, Scout Lab 186, Harvest Manager 188, Test Lab Manager 190, Application Lab 192, Vehicle Manager 194, Event Data Import 196, and Event Editor 198. The software modules of Data Validation System 158 include Soil Test Module 200, Harvest Import Module 202, Harvest Cleansing Module 204, Scout Lab Module 206, Harvester Manager Module 208, Test Lab Module 210, As-Applied Module 212, and Vehicle Data Management System 214. The database contained in Data Validation System 158 is Vehicle File Database 216. The sub-programs internally accessed by Data Validation System 158 are Customer Data Management System 162 and Spatial Data Management System 168.

The information imported or entered into Mapping Software 100 is either site-specific information or whole-field data. Site-specific information contains information for specific sections of a field, such as soil samples or harvest yields collected for every tenth of an acre. Whole-field data contains samples of information taken for an entire field, such as the yield for an entire field. Data Validation System 158 recognizes the type of information being imported and handles the information accordingly. For example, site-specific information is broken down by a number of polygons that represent an entire field. Each polygon contains specific information, such as soil samples or scouting information. Whole-field data, on the other hand, is represented by one polygon. The polygon for whole-field data is the same as the field boundary. When whole-field data is used to create maps, the information can be averaged and broken into site-specific polygons.

Once the information has been imported, it is cleansed and validated using the various software interfaces and modules of Data Validation System 158. Next, the information is tagged with meta data, which comes from information stored in Customer Data Management System 162. The information is also verified by the user before being stored.

Event Data Import 196 is the software interface responsible for assigning meta data to the information and verifying the accuracy of the information. Event Data Import 196 tags all imported information with meta data. If this step is skipped, Event Data Import will not send the information to Spatial Data Management System 168 for storage. One of the key features of Mapping Software 100 is how it stores the information. Each piece of data imported into Mapping Software 100 is stored by its actual location. In other words, the information is not associated with a specific field, but instead is associated with its latitude and longitude coordinates. This allows easier access and manipulation of the data because a spatial query can be done on the entire database instead of searching each field. If information is associated with five different fields, it does not get trapped in five different locations. Thus, if the information needs to be combined into one field, it can easily be retrieved. The information is also tagged with meta data. Meta-data is information that describes the data being imported, such as when the data was collected, who collected the data, who owns the data, the field associated with the data, the weather conditions at the time the data was collected and any other relevant information.

Event Data Import 196 accesses Customer Data Management System 162 to obtain the meta data needed to tag the imported data. The user assigns an owner and field to the information. For example, the information may belong to Farmer Jones. If Farmer Jones owns two fields, Customer Data Management System 162 will bring up information for both fields to help the user select the correct field. If the information belongs in the first field, the user can verify that the information falls in Field One.

Event Data Import 196 accesses Event Editor 198 to obtain a visual display of the imported data. The user can visually see where specific information is located and if it falls within the specified boundary. Thus, if the information imported for Farmer Jones' field belongs in the first field, but Event Editor 198 shows the information falls in the second field, the user will notice a problem before the information is sent to Spatial Data Management System 168. If the information is located in the wrong place or the data appears to be erroneous, the user can correct the information using Event Editor 198. Once the information has been tagged and verified, it is sent to Spatial Data Management System 168 for storage.

Mapping Software 100 access Spatial Data Management System 168 to obtain the agronomic information needed to create maps. Spatial Data Management System 168, as explained below in further detail below, stores multiple years of information, which provides the user with greater flexibility. For example, the yield for a particular field can be calculated as an average or a weighted average over a number of years, thus providing a more accurate number than using information from one year.

The information collected by Grid Sampler 144 and Farm-GPS System 145 is combined using Soil Test Import 180. The soil samples taken by Grid Sampler 144 are first sent to a lab and analyzed. The soil information is then combined with the appropriate grid location to form a map of the soil samples. The soil map is also sent to Soil Test Module 200, where the integrity of the data is checked and cleansed if necessary. The information is then sent to Event Data Import 196 to be tagged and verified by the user.

Harvest Import 182 provides a user-interface for the entry of yield data collected from harvesting crops. Once the data is imported by Harvest Import 182, the user associates meta data with the yield data. The data is sent to Harvest Import Module 202, where it is converted to a standard format used by Mapping Software 100. The final step is to send the data to Event Data Import 196 to be tagged and verified by the user.

Harvest Cleansing 184 provides a user interface for checking the integrity of the harvest data imported by Harvest Import 184, and if necessary, sends the data through a cleansing process. Harvest Cleansing Module 204 is responsible for the cleansing process. The cleansing process may involve a number of different steps. For example, if there is a five second delay before material at the cutting head of a combine gets to the sensor on the combine, Harvest Cleansing Module 204 can compensate for this delay. Once the data is converted and validated, it is sent to Event Data Import 196.

Scout-Lab 186 provides a user interface for importing the information collected by Scout It 148. The information collected by Scout It 148 is stored on Scout Data 110 and then transferred to the computer where Mapping Software 100 is loaded. Scout Lab Module 206 performs a final clean-up on the information imported by Scout Lab 186. Once the information is validated, it is sent to Event Data Import 196.

Harvest Manager 188 provides a user interface that is responsible for handling the various formats of yield data imported by Harvest Import 182. Yield data is stored in various formats due to the numerous types of harvest equipment used by farmers. Each type of harvest equipment stores yield information in a unique format. Harvest Manager 188 allows the user to import various formats of yield data that are converted by Harvest Manager Module 208. In addition, Harvest Manager 188 allows the user to combine yield information collected by multiple combines on the same field. The information is merged and forms one map.

Test Lab Manager 190 provides a user interface for manipulating the various information imported by Data Validation System 180. Test Lab Module 210 allows a user to reformat or merge data before it is stored.

Application Lab 192 is a user interface that imports As-Applied Data 116 and creates As-Applied Maps 134. As-Applied Maps 134 provide information on the agricultural products applied to each pre-defined section of a field, such as every tenth of an acre. The information imported by Application Lab 192 is sent to As-Applied Module 212, where it is validated and cleansed. Once the information is cleansed, it is sent to Event Data Import 196. The information can also be sent from As-Applied Module 212 to Central Agricultural Station 130 for further analysis.

Central Agricultural Station 130 is a geographically referenced system that is accessed via the Internet. Central Agricultural Station 130 contains analytical tools that are not available on the desktop version of Mapping Software 100. Central Agricultural Station 130 allows the user to access, organize, manipulate and analyze data in order to obtain new information that can be used in creating Controller Application Maps 132.

Vehicle Manager 194 is a software interface that organizes and analyzes information related to the capabilities of various application machines. Vehicle Data Management System 214 organizes the information received from Vehicle Profile Data 122 and stores it in Vehicle File Database 216. The information is organized so that a user can select a machine based on field conditions or the type of crop inputs being applied to a field. This information is used by Prescription Mapping System 160 to develop Demo Application Maps 136.

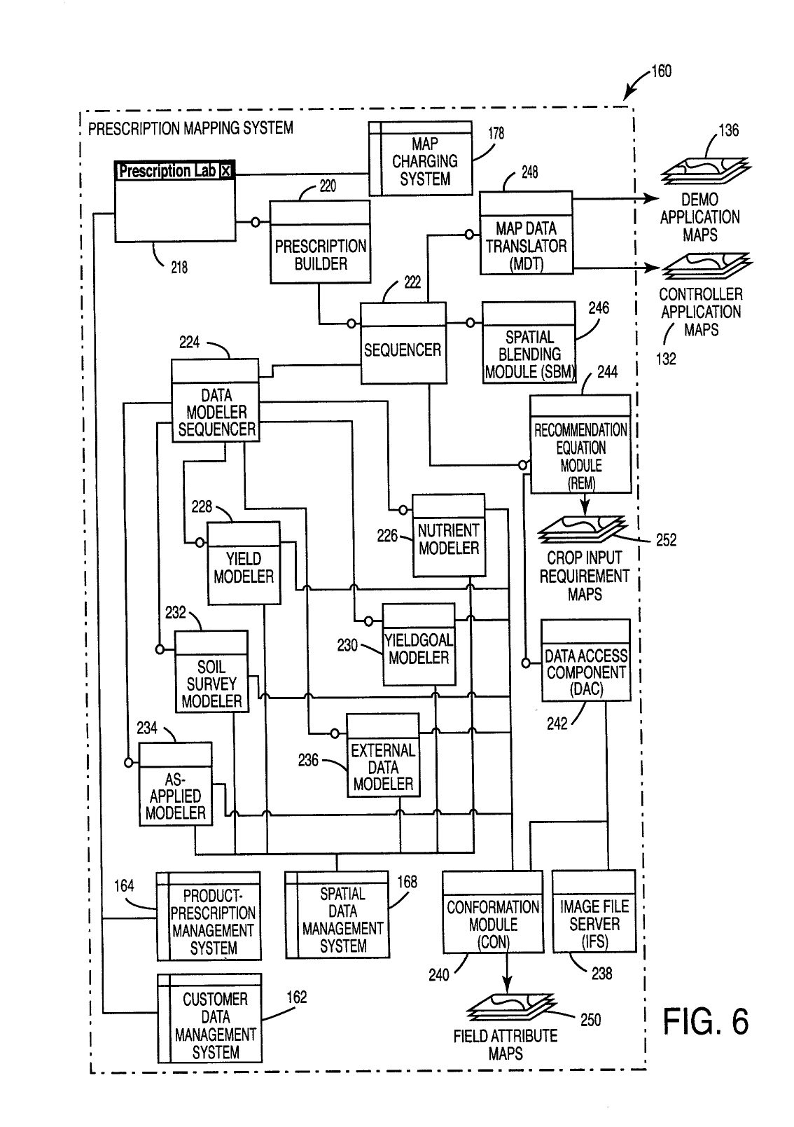

6. Prescription Mapping System 160 (FIG. 6)

The internal components of Prescription Mapping System 160 are shown in FIG. 6. The software interface of Prescription Mapping System 160 is Prescription Lab 218. The software modules are Prescription Builder 220, Sequencer 222, Data Modeler Sequencer 224, Nutrient Modeler 226, Yield Modeler 228, Yield Goal Modeler 230, Soil Survey Modeler 232, As-Applied Modeler 234, External Data Modeler 236, Inage File Server (IFS) 238, Conformation Module (CON) 240, Data Access Component (DAC) 242, Recommendation Equation Module (REM) 244, Spatial Blending Module (SBM) 246, and Map Data Translator (MDT) 248. The internal maps of Prescription Mapping System 160 are Field Attribute Maps 250 and Crop Input Requirement Maps 252. The external outputs of Prescription Mapping System 160 are Demo Application Maps 136 and Controller Application Maps 132. The sub-programs accessed by Prescription Mapping System 160 are Customer Data Management System 162, Product-Prescription Management System 164, Spatial Data Management System 168, and Map Charging System 178.

Prescription Lab 218 is a software interface that allows a user to create, store, and print prescription maps based on guidelines entered by the user. Once the maps are created, they are stored in Spatial Data Management System 168 or used by the grower to apply agricultural products to a field. The maps can be printed using Map Charging System 178.

Prescription Builder 220 and Sequencer 222 are responsible for calling the modules needed to create Field Attribute Maps 250. Prescription Builder determines what information is needed to create the map and creates a plan for sequencing through the various software modules of Prescription Mapping System 160. Sequencer 222 uses the plan from Prescription Builder 220 to sequence through the appropriate software modules needed to create the map.

Data Modeler Sequencer 224 controls the various modelers in Prescription Mapping System 160. Sometimes only one modeler is used to create a map, but often multiple modelers need to be accessed to obtain the information needed for a map. Data Modeler Sequencer 224 accesses the necessary modules and provides the information to Conformation Module 240 and Image File Server 238. If Data Modeler Sequencer 224 cannot find the information needed to create a map, it sends a message to Prescription Lab 218 that the information is not available. Prescription Lab 218 informs the user that additional data needs to be imported or entered before Prescription Mapping System 160 can create a map.

There are a number of data modelers, each responsible for handling a unique type of data. Based on the type of data stored, each modeler knows how to retrieve the information needed from Spatial Data Management System 168. Each data modeler can also manipulate the data into new formats that are beneficial to the map making process, such as converting three years of yield information into a weighted average of yield information.

Nutrient Modeler 226 handles soil sampling information, which contains information on the nutrients found in specific samples of soil. If the information retrieved by Nutrient Modeler 226 is not current, Nutrient Modeler 226 can update the information. For example, if Nutrient Modeler 226 retrieves soil test results that are three years old, Nutrient Modeler can access As-Applied Modeler 234 to determine if it can retrieve As-Applied Data 116 for the past three years. If the data exists, Nutrient Modeler 226 can use the information to update the soil nutrient information. Nutrient Modeler 226 can look at the type of nutrients added to the field as well as the type of crops grown in the field and how much they depleted the nutrients in the field. The end result is a more accurate depiction of the nutrients left in the soil after three years.

Yield Modeler 228 is responsible for information related to the results of harvesting crops. Yield information can be manipulated in a number of different ways, such as averaging the data or taking a weighed average over a number of years. Yield Goal Modeler 230 uses the yield information to establish yield goals for a field. Thus, Prescription Mapping System 160 uses the yield goals defined for a specific field to create a map that applies crop inputs that in theory should give the grower the desired yield for the field.

Soil Survey Modeler 232 handles information related to the results of soil surveying, such as whether the soil is clay or sand. This type of information can be useful in establishing yield goals. If a sandy section of a field contained a high level of nitrogen when soil sampling was done, based on a recent application of nitrogen, but since that time has received hard rains, the sandy conditions of the soil cannot hold the nitrogen. Therefore, the user can adjust the nitrogen levels in the sandy soil to reflect the recent rains. On the other hand, a user may know that sandy soil cannot produce huge yields and use the information from Soil Survey Modeler 232 to establish lower yield goals wherever there is sandy soil, despite the nutrients found in the soil.

As-Applied Modeler 234 is responsible for the information obtained during the application of agricultural products. As described previously, this information can be used to adjust information that is no longer current. As-Applied Modeler 234 can also check previous applications to make sure that future chemicals will not react with chemicals already applied to the field or crops planted in the field.

External Data Modeler 236 handles Background Data 120, which is, for example, information imported into Mapping Software 100 related to township, boundary, and soil data for the majority of the U.S. This information can be used to adjust or compare other imported information.

Image File Server (IFS) 238 and Conformation Module (CON) 240 transform the information from the data modelers. Image File Server 238 converts the information into a graphical format that can be viewed by the user. CON 240 changes the polygon or point data into a single surface or layer of data using interpolation methods. This step places the information into a grid format that no longer requires the information to be referenced by longitude and latitude, but rather breaks the field into a grid that contains a single layer of information for each cell of the grid. The output of CON 240 is Field Attribute Maps 250, which contains all the agronomic data for each section of the field. Each type of data, such as soil nutrients, is represented by one of the maps of Field Attribute Maps 250.

Data Access Component (DAC) 242 determines what information is needed for the next phase of the mapping process and pulls the information from CON 240. DAC 242 accesses the information on a section by section basis, thus DAC 242 can retrieve all the information needed for one section of the field. This allows Prescription Mapping System 160 to create the prescription of crop inputs needed for that section of the field and then move on to the next section of the field.

Recommendation Equations Module (REM) 244 combines the information from Field Attribute Maps 250 and Recommendation Equations 124, shown in FIG. 1, to create a prescription of crop inputs (e.g. such as nitrogen, phosphorous, or potassium) for each subsection of a field. The output of REM 244 is Crop Input Requirement Maps 252. REM 244 is described in further detail below.

Spatial Blending Module (SBM) 246 is responsible for converting the crop inputs defined in Crop Input Requirement Maps 252 into a blend of agricultural products that can be applied to a field. Spatial Blending Module 246 uses a variety of information to create agricultural product maps, referred to as Demo Application Maps 136. The most important input is Product Information 126. Product Information 126 contains the percentage of crop inputs in each product, such as the percentage of phosphorus or potassium in the product. The other inputs that may be used by SBM 246 are blending instructions, machine constraints, vehicle constraints, product carrier constraints, and economic restrictions. SBM 246 is explained in further detail in Section 25 below.

The blend of agricultural products created by SBM 246 is sent to Map Data Translator (MDT) 248. The interface for MDT 248 is Map Translator 338, which is part of Map Charging System 178 and accessed through Prescription Lab 218. MDT is responsible for the creation of Demo Application Maps 136 and Controller Application Maps 132. MDT converts the blend of agricultural products created by SBM 246 into a Geographical Tagged Image File Format (GeoTIFF), which is a geographical format with unique data tags. The unique data tags added by MDT 248 include, but are not limited to, checksum, paid-for-flag, and expiration dates. MDT is explained in further detail in Section 28 below.

Once Spatial Blending Module 246 and Map Data Translator have finished generating Demo Application Maps 136 and Controller Application Maps 132, the maps can be viewed or printed. At this point the user may wish to change some of the constraints and create a new map. Based on the user's new request, Sequencer 222 determines what information already exists from the previous map and what information is new. Thus, Sequencer 222 only needs to access the data modelers needed to create the new information. This makes the process more efficient and saves time during the map making process.

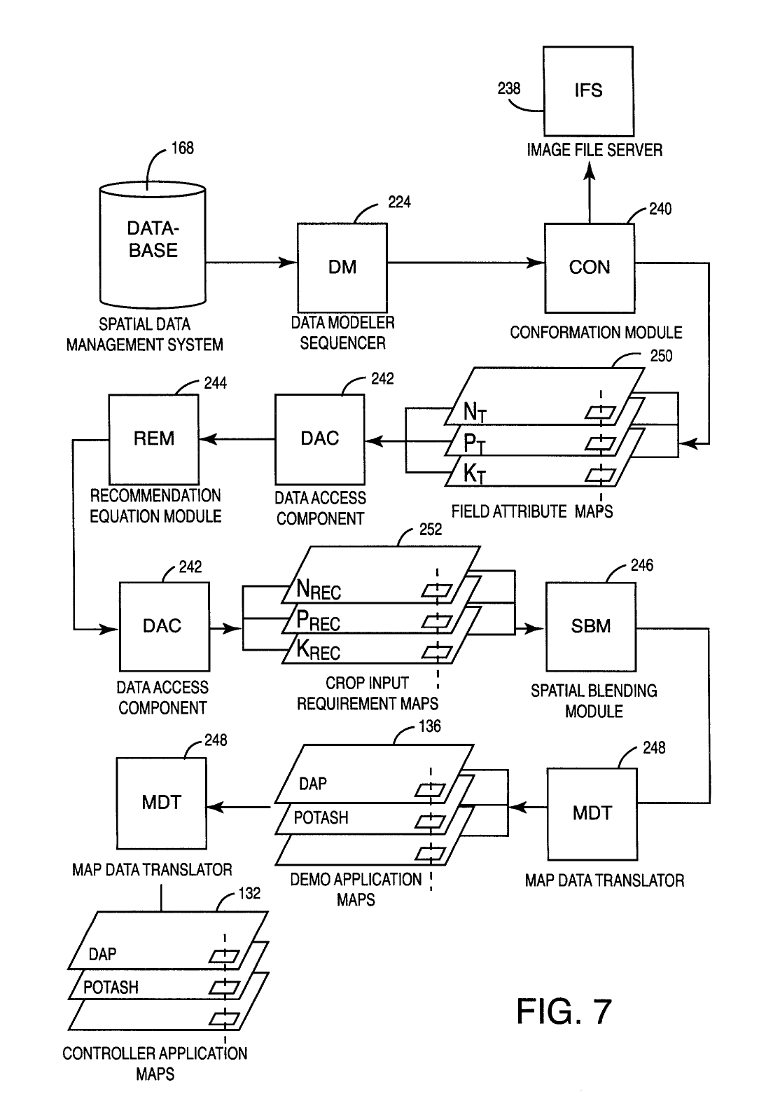

7. Process Flow of Prescription Mapping System (FIG. 7)

FIG. 7 is a flow-diagram of the map making process of Prescription Mapping System 160. The software modules in FIG. 7 are Data Modeler Sequencer (DM) 224, Image File Server (IFS) 238, Conformation Module (CON) 240, Data Access Component (DAC) 242, Recommendation Equation Module (REM) 244, and Spatial Blending Module (SBM) 246. The maps created by Prescription Mapping System 160 are Field Attribute Maps 250, Crop Input Requirement Maps 252, Demo Application Maps 136, and Controller Application Maps 132. The database accessed is part of Spatial Data Management System 168.

As explained above, Sequencer 222 is responsible for accessing the various software modules needed for the map making process. Based on the plan established by Prescription Builder 220, shown in FIG. 6 and explained above, Sequencer 222 knows what agronomic information is needed by REM 244 to create Agronomic Prescription Maps 252. The agronomic information sed by REM 244 must be in the form of a map broken down by sections which can be referenced using “x” and “y” coordinates. Thus, the first step is to create Field Attribute Maps 250.

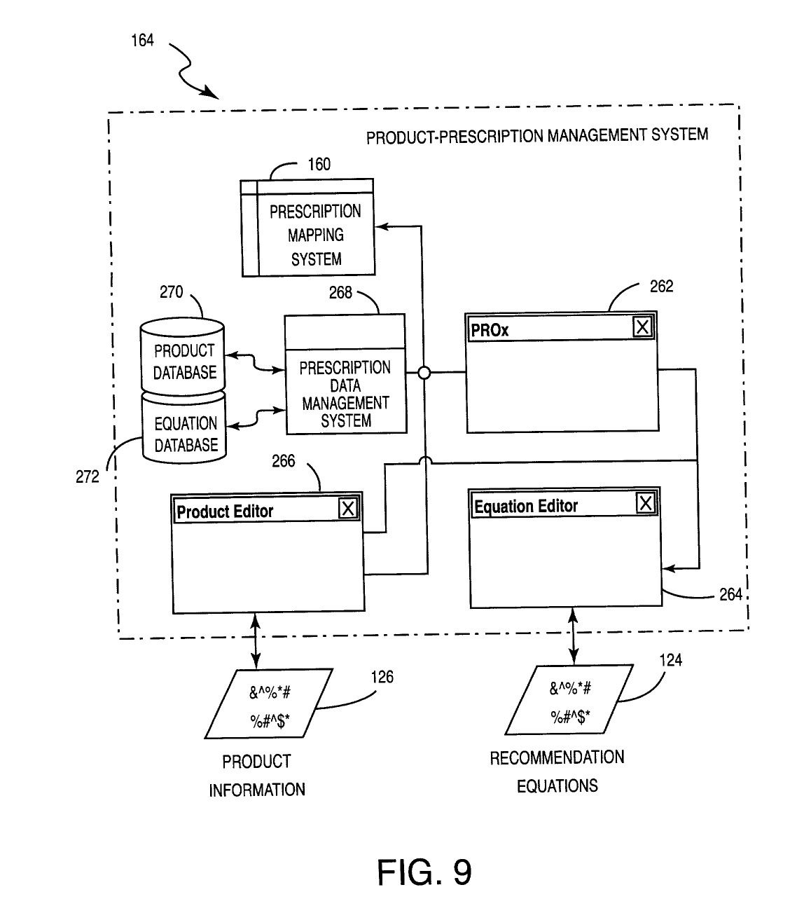

To create Field Attribute Maps 250, Sequencer 222 starts by accessing DM 224. DM 224 accesses the various data modelers needed. Each data modeler pulls data from the database contained in Spatial Data Management System 168. Each data modeler also performs any data manipulation necessary to fit the profile of data needed by REM 244. Next, Sequencer 222 accesses CON 240 to convert the information into a standard format, as described above. The end result is Field Attribute Maps 250. At this point, CON 240 can also use IFS 238 to create a graphical representation of the data that be viewed by the user Once Field Attribute Maps 250 are created, DAC 242 stacks the information and accesses all the information one section or cell at a time. REM 244 uses the information accessed by DAC 242 and Recommendation Equations 124 to determine the prescription of raw ingredients needed for each section of the field. REM 244 accesses Recommendation Equations 124 from Product-Prescription Management System 164, which is shown in FIG. 9 and explained in further detail below. As each crop input needed for a specific section of the field is created, REM 244 uses DAC 242 to organize the information and create a new stack of maps that contain the individual crop inputs needed for each section of the field. The new stack of maps is referred to as Crop Input Requirement Maps 252.

Sequencer 222 accesses SBM 246 and MDT 248 to create Demo Application Maps 136. SBM 246 uses the information from Crop Input Requirement Maps 252, Product Information 126, and other user information, as described below, to create an optimal blend of agricultural products. SBM 246 retrieves Product Information 126 from Product-Prescription Management System 164, which is shown in FIG. 9 and explained in further detail below. SBM 246 retrieves the other information used to create Demo Application Maps 136 from other inputs of Mapping Software 100. MDT 248 converts the blend of agricultural products into Demo Application Maps 136 by converting the blend of products to a GeoTIFF format, as described above. The GeoTIFF format is required by Application Control System 106. Thus, a user cannot use the blend of agricultural products created by SBM 246 to apply products to a field until the information has been converted to the GeoTIFF format. Although Demo Application Maps 136 are in the proper format to be used by Application Control System 106, the maps cannot be used until Mapping Software 100 confirms that the maps are paid for. At this point, Demo Application Maps 136 can be viewed and edited as needed until the user is satisfied with the final result and pays for the maps.

Controller Application Maps 132 represent maps that have been paid for and are ready to be used by Application Control System 106. MDT 248 is responsible for the creation of Controller Application Maps 132. MDT 248 adjusts the unique data tags of the GeoTIFF format according to the paid for status of Demo Application Maps 136. Once the maps have been paid for, they can be used to apply agricultural products to a field.

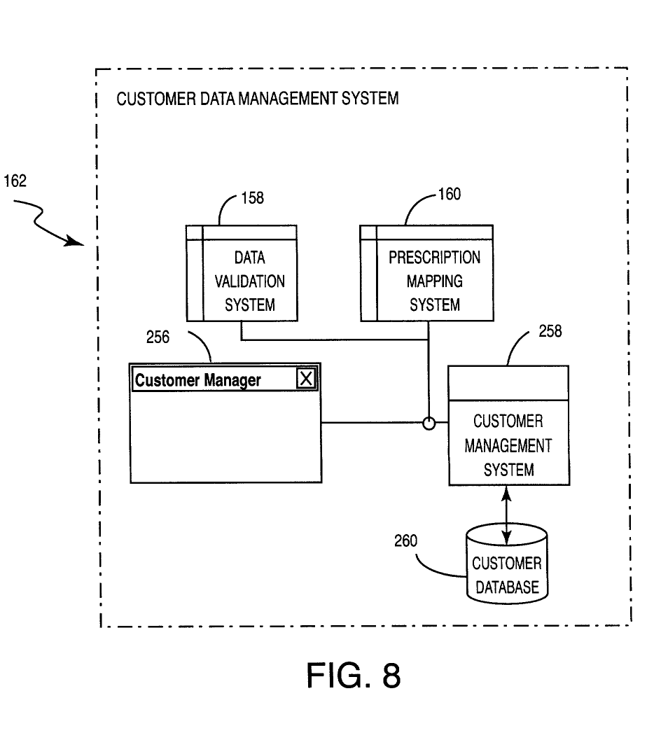

8. Customer Data Management System 162 (FIG. 8)

Customer Data Management System 162 is shown in FIG. 8. Customer Data Management System 162 organizes and stores information that is used by Prescription Mapping System 160 to create Demo Application Maps 136. The software interface module of Customer Data Management System 162 is Customer Manager 256. Customer Management System 258 is a software module and Customer Database 260 is a database. Customer Data Management System 162 also includes Data Validation System 158 and Prescription Mapping System 160, which are the sub-programs internally accessed by Customer Data Management System 162.

Customer Manager 256 is a software interface that allows the user to organize information associated with a specific field. The agronomic data associated with a field comes from Data Validation System 158. In addition to agronomic data, meta data is manually entered using Customer Manager 256. Meta data includes information such as location of a field, ownership of a field, history of weather, damage to crops in a field, etc. The agronomic and meta data can be organized in various ways. For example, the user can combine multiple fields into a single file, organize the fields based on the type of crops grown, or create a history file for each field.

Customer Management System 258 is a software module that sorts and organizes agronomic and meta data according to a user's criteria. Customer Management System 258 also retrieves information needed by Prescription Mapping System 160. The information is stored in and retrieved from Customer Database 260.

9. Product-prescription Management System 164 (FIG. 9)

FIG. 9 shows the components of Product-Prescription Management System 164. Recommendation Equations 124 and Product Information 126 are both inputs and outputs of Product-Prescription Management System 164.

The internal components of Product-Prescription Management System 164 include software interface modules PROx 262, Equation Editor 264, and Product Editor 238. The software modules are Prescription Data Management System 268, Product Database 270, and Equation Database 272. Product-Prescription Management System 164 also includes Prescription Mapping System 160, which is a sub-program internally accessed by Product-Prescription Management System 164. Product-Prescription Management System 164 is responsible for organizing and manipulating information from Recommendation Equations 124 and Product Information 126.

PROx 262 is a software interface that allows the user to import, export, or manually enter Recommendation Equations 124. In addition, Product Information 126 can be imported or manually entered using PROx 262. PROx 262 calls up Equation Editor 264 as the user interface for entering Recommendation Equations 124. Likewise, PROx 262 accesses Product Editor 266 for entering Product Information 126.

Equation Editor 264 works with the user to develop recommendation equations that are acceptable by REM 226. First, Equation Editor 264 checks the syntax of the equation entered by the user. If the syntax is correct, the equation is sent to REM 226. If the syntax generates an error, Equation Editor 264 highlights the problem and helps the user correct the equation.

Product Editor 266 allows the user to enter Product Information 126, which is product information not currently stored by Mapping System 100. Product Editor 266 prompts a user for the required information, which can be imported or manually entered. Once Product Information 126 has been input, the user can select the information for use in developing Demo Application Maps 136.

Prescription Data Management System 268 organizes and stores information in Product Database 270 and Equation Database 272. Product Database 270 contains information related to the contents of each product. The product information may be pre-loaded as part of Mapping System 100 or entered by the user, as described above, using Product Editor 266. Equation Database 272 stores pre-defined and user-defined recommendation equations. The equations may also be pre-loaded or entered by the user.

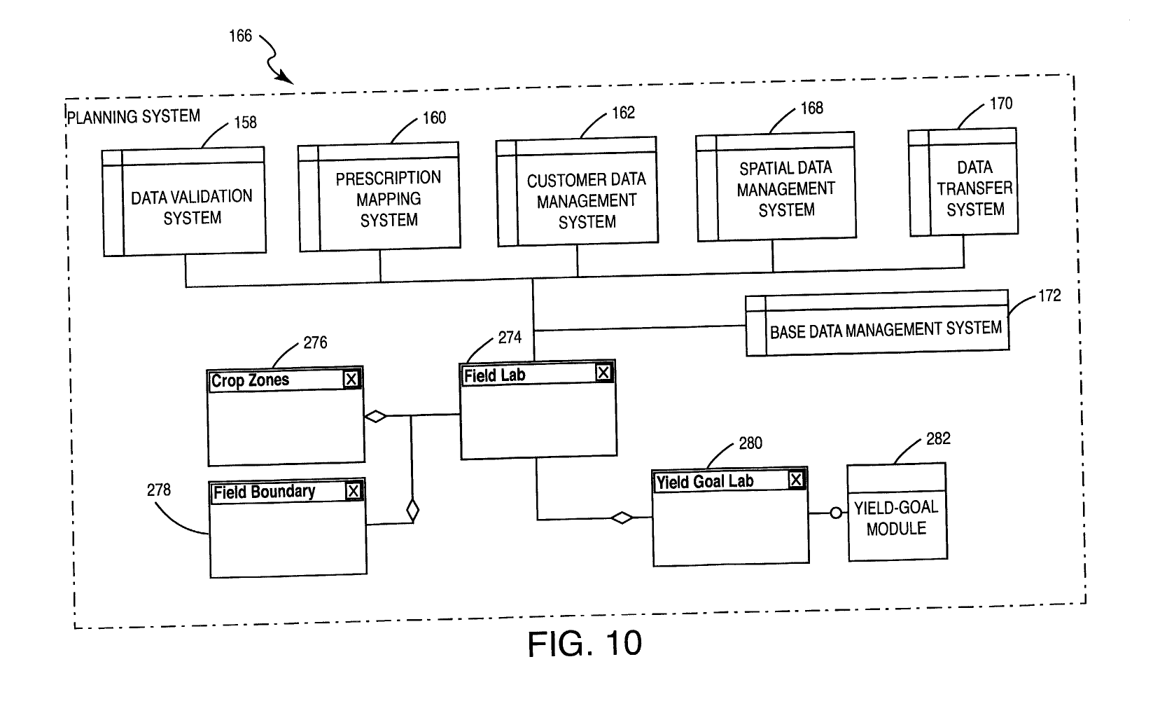

10. Planning System 166 (FIG. 10)

The components of Planning System 166 are shown in FIG. 10 The software interface modules of Planning System 166 include Field Lab 274, Crop Zones 276, Field Boundary 278, and Yield Goal Lab 280. Planning System 166 also includes software module Yield Goal Module 282. The sub-programs internally accessed by Planning System 166 are Data Validation System 158, Prescription Mapping System 160, Customer Data Management System 162, Spatial Data Management System 168, Data Transfer System 170, and Base Data Management System 172.

Field Lab 274 provides the main interface to Mapping Software 100. Field Lab 274 gives the user access to all the tools of Mapping Software 100, such as creating an application map, generating a soil test report, or managing site-specific information. For example, if the user wants to create an application map, Field Lab 274 accesses Prescription Mapping System 160, which takes the user through the steps of defining the map and determining if the information needed to create the map is available. At the same time, Mapping Software 100 allows the user to manage other aspects of site-specific farming, such as defining field boundaries or yield goals.

Crop Zones 276, Field Boundary 278 and Yield Goal Lab are sub-interfaces of Field Lab 274. Crop Zones 276 is a software interface that allows the user to define the crop zones of a field. The user can access other information stored by Mapping Software 100, such as soil fertility and crop yields, to determine the best way to set up crop zones.

Field Boundary 278 is used to change or create field boundaries. As explained above, Mapping Software 100 stores agronomic information based on the location of the information in the field and then tags the information based on the owner of the field. This allows the boundaries of a field to easily be manipulated. A user can create a new field boundary that includes two existing fields without needing to merge the existing fields into a third field. Thus, if the two fields were previously owned by different growers, a new field can be created without merging information from files stored under different owners.

Yield Goal Lab 280 works with Yield Goal Module 282 to organize site-specific farming information based on the grower's desired yield goal. For example, based on the goal set for a specific year, soil sampling may be done in the spring, herbicide can be applied accordingly during the summer months and fertilizer may be applied in the fall. Yield Goal Lab 280 organizes the various applications and tests done on a field according to the date of the application. The overall goal is to achieve a certain yield based on the chemicals applied to the field throughout the year. The plans can be accessed in later years for use in creating a new plans.

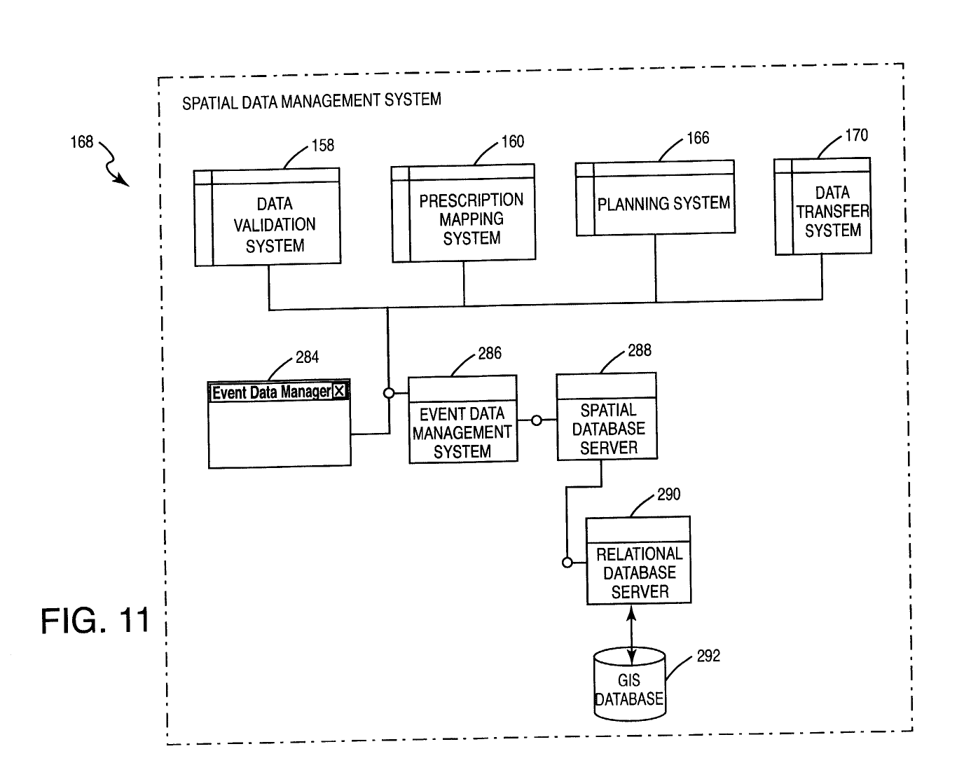

11. Spatial Data Management System 168 (FIG. 11)

FIG. 11 shows the operation of Spatial Data Management System 168. Spatial Data Management System 168 includes software interface Event Data Manager 284. The software modules of Spatial Data Management System are Event Data Management System 286, Spatial Database Server 288, and Relational Database Server 290. The database of Spatial Data Management System 168 is GIS Database 292. The sub-programs internally accessed by Spatial Database Management System 176 are Data Validation System 158, Prescription Mapping System 160, Planning System 166, and Data Transfer System 170. Overall, Spatial Data Management System 168 is the main database responsible for the storage of information used by Mapping Software 100.

Event Data Manager 284 is a computer interface that allows the user to store information based on events related to site-specific farming. For example, the application of fertilizer is one event, the planting of corn is another event, and spraying insects is a third event. While all the information is related to one field, it is stored based on the associated event.

Event Data Management System 286 is responsible for organizing the information in Mapping Software 100 based on specific events. Event Data Management System 168 works with GIS Database 292 to store and retrieve the information. The information is either graphical or relational and stored accordingly.

The graphical data is accessed using Spatial Database Server 288. Spatial Database Server 288 access information based on field locations; thus, all the information for one field boundary can be stored together. The relational data uses Relational Database Server 290 to store and retrieve information. Relational Database Server 290 accesses information based on its relationship to other information. For example, the soil samples taken in a given field may be associated with a certain field, which in turn can be associated with a particular owner.

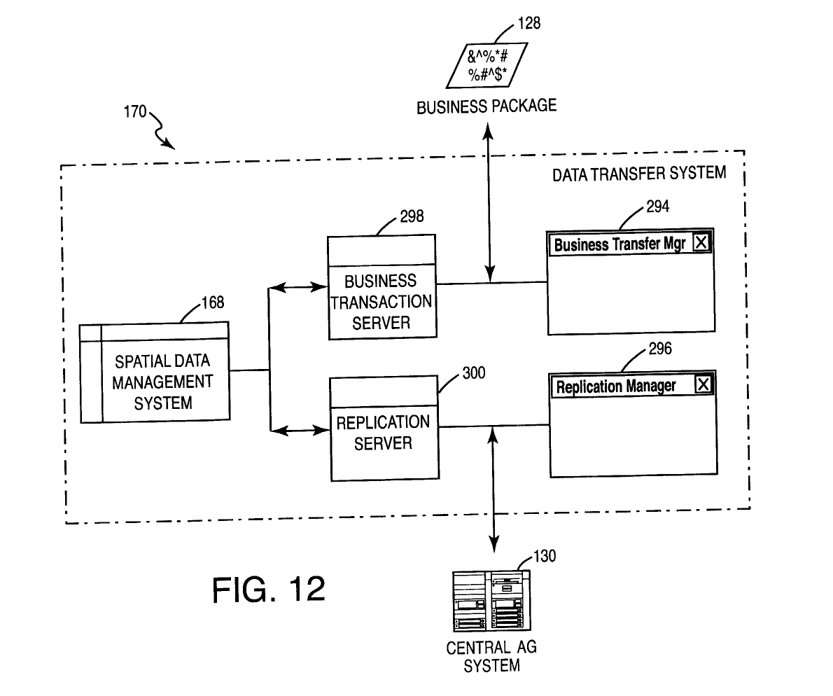

12. Data Transfer System 170 (FIG. 12)

Data Transfer System 170 is shown in FIG. 12. The user interfaces of Data Transfer System 170 are Business Transfer Manager 294 and Replication Manager 296. The software modules of Data Transfer System 170 include Business Transaction Server 298 and Replication Server 300. Spatial Data Management System 168 is the sub-program accessed by Data Transfer System 170. Business Packages 128 represents both an input to and an output from Data Transfer System 170. Central Ag Station 124 is an output of Data Transfer System 170.

Business Transfer Manager 294 is a software interface that allows the user to integrate third-party business and accounting packages with Mapping Software 100. Business Transfer Manager 294 accesses Business Transaction Server 298. Business Transaction Server 298 retrieves information needed by business or accounting packages, such as the costs associated with creating a map for a field. The information exchanged is represented by Business Packages 128.

Replication Manager 296 and Replication Server 300 work together to transfer information back and forth between Central Ag Station 124. This allows the user to verify information with Central Ag Station 124. At the same time Central Ag Station 124 can collect information from numerous users to use for future development of site-specific farming systems.

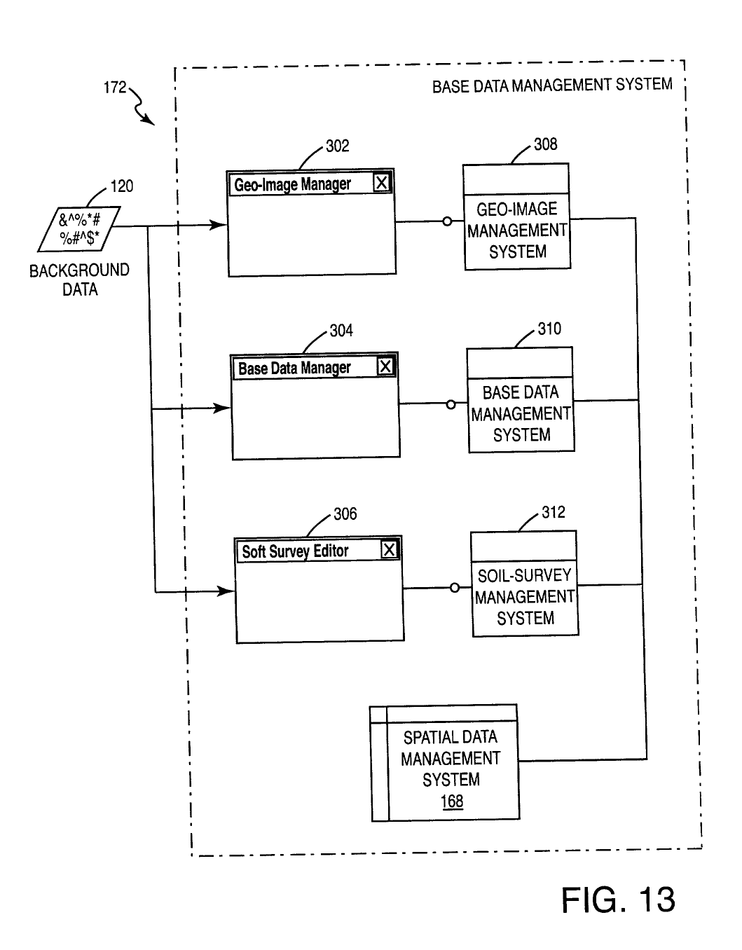

13. Base Data Management System 172 (FIG. 13)

Base Data Management System 172 is shown in FIG. 13. Base Data Management System 172 includes software interface modules Geo-Image Manager 302, Base Data Manager 304, and Soil Survey Editor 306. The software modules are Geo-Image Management System 308, Base Data Management System 310, and Soil Survey Management System 312. Base Data Management System 172 also internally accesses Spatial Data Management System 168. The input to Base Data Management System 172 is Background Data 120.

Geo-Image Manager 302 provides an interface for importing geo-image data from Background Data 120. Geo-image data 118 includes section surveys for the majority of the U.S. Once the information has been imported, Geo-Image Management System 308 organizes the information and transforms the information into a format that can be used by Mapping Software 100. The information is then stored by Spatial Data Management System 168 for future access.

Base Data Manager 304 provides a user interface for importing and organizing base data from Background Data 120. Base data is agricultural information that is obtained by government agencies and made available to the public. Base data is usually broken down by state, county, and subsections of each county. The agricultural information includes soil type, topography, rainfall, etc. Base Data Management System 310 assists Base Data Manager 304 in organizing and converting the information to a format acceptable by Mapping Software 100. Once the information has been converted, it is sent to Spatial Data Management System 168 for storage and future retrieval. Soil Survey Editor 306 is a software interface used to import soil-survey data from Background Data 120. Soil Survey Management System 312 organizes and reformats the soil-survey data. Once the information is reformatted, it is sent to Spatial Data Management System 168 to be stored for future use by Mapping Software 100.

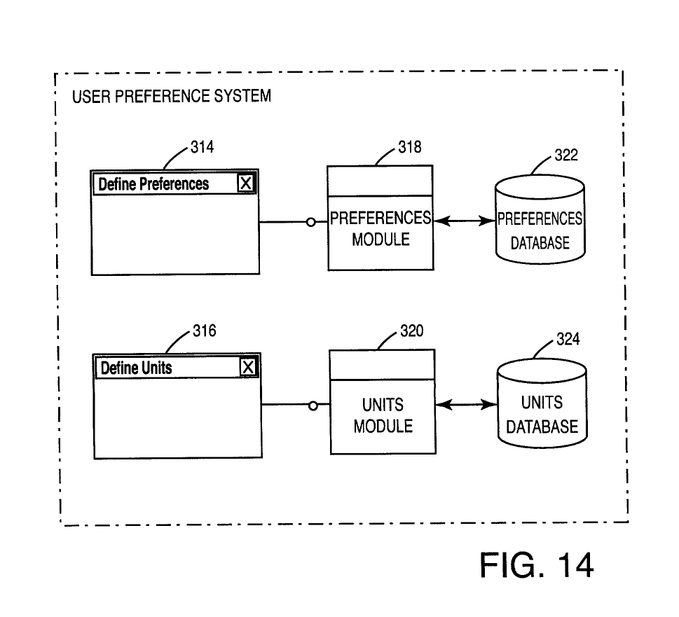

14. User Preference System 174 (FIG. 14)

User Preference System 174 is shown in FIG. 14. User Preference System 174 includes software interface modules Define Preferences 314 and Define Units 316. The software modules and databases of User Preference System 174 are Preferences Module 318, Units Module 320, Preferences Database 322, and Units Database 324.

Define Preferences 314 allows each user to individualize the format of Mapping Software 100. The format includes all the features related to the software interface modules, such as color, font, language, backup file location, etc. Preference Module 318 organizes each the preferences for each user and Preferences Database 322 stores the information.

Likewise, Define Units 316 allows each user to individualize the units of measure. Units Module 320 organizes the units specified by user and Units Database 324 stores the information.

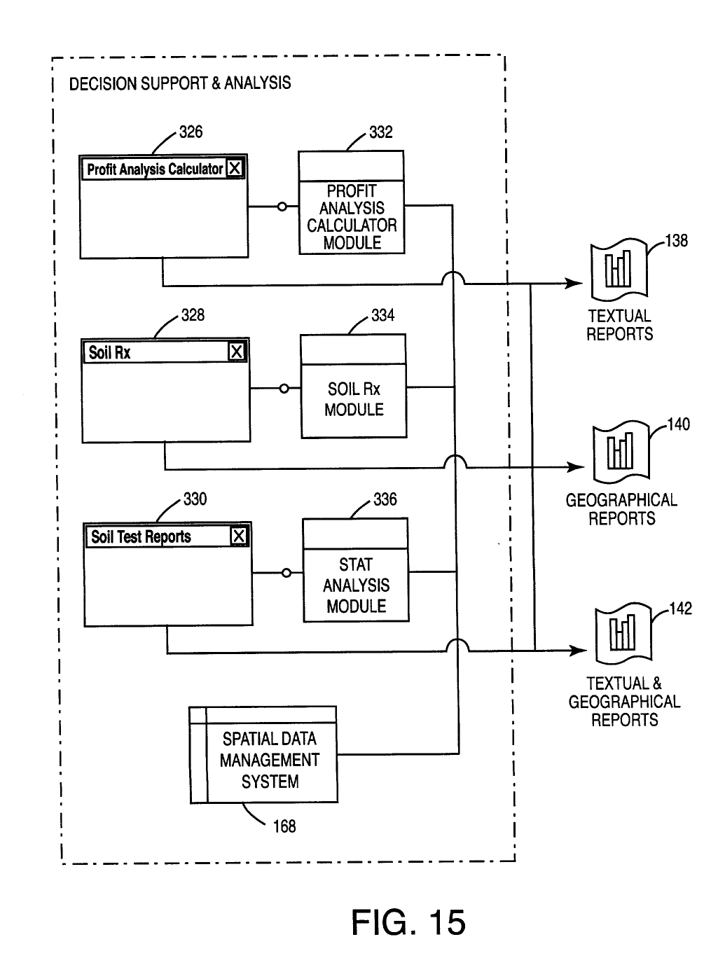

15. Decision Support & Analysis System 176 (FIG. 15)

FIG. 15 shows the components of Decision Support & Analysis 176. Decision Support & Analysis System 176 comprises software interface modules Profit Analysis Calculator 326, Soil Rx 328, and Soil Test Reports 330. The software modules include Profit Analysis Calculator Module 332, Soil Rx Module 334, and Stat Analysis Module 336. The outputs of Decision Support & Analysis System 176 include Textual Reports 138, Geographical Reports 140, and Textual & Geographical Reports 142.

Profit Analysis Calculator 326 compares a variable-rate application of agricultural products with a flat-rate application for a targeted field. Profit Analysis Calculator 326 uses broadly accepted soil fertility nutrition concepts to predict the response of a variable-rate application. Two different methods are used to show the benefit of using a variable-rate application. The first method shows the potential for yield increases in nutrient-limited areas. The second method shows the potential for fertilizer savings in areas with high quality soil.

Profit Analysis Calculator Module 332 uses soil fertility information to calculate and compare the results of using a variable-rate to a flat-rate application. The information used by Profit Analysis Calculator Module 332 is retrieved from Spatial Data Management System 168. Profit Analysis Calculator 326 generates Textual Reports 138, Geographical Reports 140, and Textual & Geographical Reports. This gives the user a variety of formats for viewing the information. The reports are internally stored by Spatial Data Management System 168 and can also be viewed by a computer, printed, or transferred to another computer system.

Soil Rx 328 generates a report of the soil sampling activity in a targeted field. The report includes a map showing the field boundary and sample locations. The sample locations are labeled with the soil test value. A user can select several options to customize the report, such as color-coded maps with legends, roads, rivers, and soil survey information.

Soil Rx Module 334 uses soil-sampling information retrieved from Spatial Data Management System 168 to create a map formatted according to the user's instructions. The maps are sent to Spatial Data Management System 168 for storage. Soil Rx 328 creates Textual Reports 138, Geographical Reports 140, and Textual & Geographical Reports 142.

Soil Test Reports 330 creates a report table for the following univariate statistics: mean, minimum, skewness, standard deviation, median, maximum, and kurtosis. Soil Test Reports 330 allows the user to request and format a report. Stat Analysis Module 336 generates statistical information based on the soil information of a specific field. The soil information used by Stat Analysis Module 336 is retrieved from Spatial Data Management System 168. Likewise, the reports created by Stat Analysis Module 336 are stored in Spatial Data Management System 168. Soil Test Reports 330 generates Textual Reports 138, Geographical Reports 140, and Textual & Geographical Reports 142.

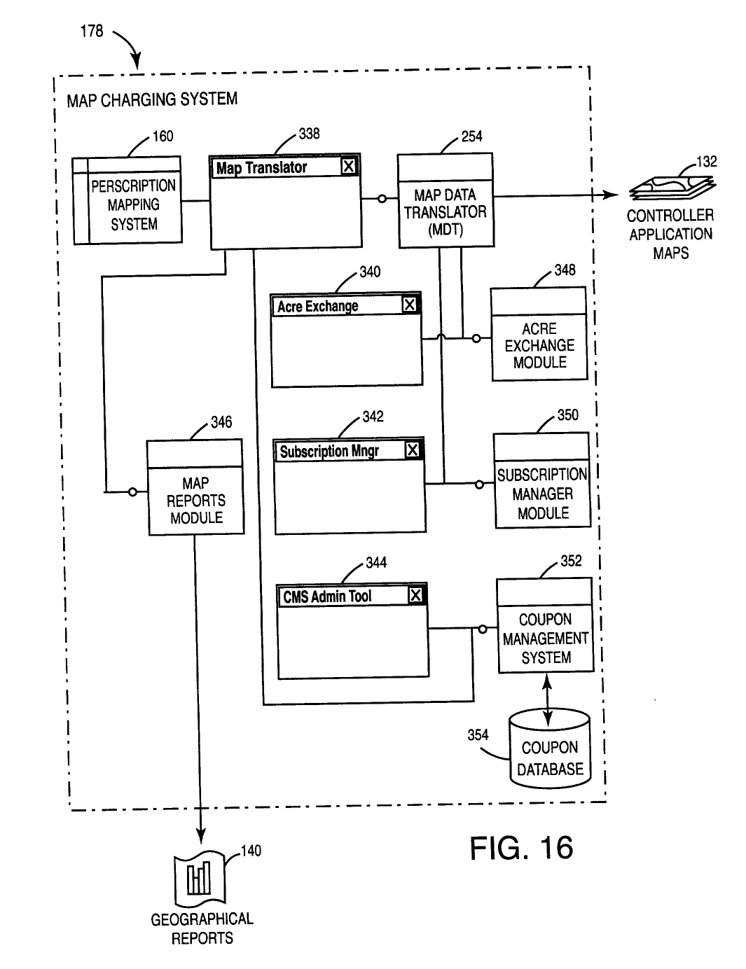

16. Map Charging System 178 (FIG. 16)

Map Charging System 178 is shown in FIG. 16. Map Charging System 178 tracks the payment and use of Controller Application Maps 132. The software interfaces of Map Charging System 178 are Map Translator 338, Acre Exchange 340, Subscription Manager 342, and Coupon Management System (CMS) Administrative Tool 344. The software modules of Map Charging System 178 include Map Reports Module 346, Map Data Translator 254, Acre Exchange 348, Subscription Manager 350, and Coupon Management System 352. Map Charging System 178 also includes Coupon Database 354 and internally accesses sub-program Prescription Mapping System 160. The output of Map Charging System 178 is Geographical Reports 140.

Map Translator 338 is a software interface that assists a user in creating Controller Application Maps 132. Map Translator 338 accesses Map Data Translator (MDT) 254, which performs two different functions. MDT 254 is accessed by both Prescription Mapping System 160 and Map Charging System 178, and thus shown and described in both FIG. 6 and FIG. 16. The first function of MDT 254 is to perform final file formatting of Controller Application Maps 132. Map Translator 338 checks the binary format and cryptographic check summing techniques used to ensure that only Mapping Software 100 creates Controller Application Maps 132. The second function performed by Map Translator 338 is the determination of final acre charges to be incurred during the creation of Controller Application Maps 132.

Acre charges incurred are based on a spatial-temporal model. In other words, the user pays for a “spot” on the ground for a period of time. Once the “spot” on the ground is paid for, Controller Application Maps 132 is created. At this point, Controller Application Maps 132 can be used to apply agricultural products to a field. To pay for the generation of a map, Map Data Translator 254 accesses Acre Exchange 340.

Acre Exchange 340 is a computer interface that allows the user to purchase and manage acres. Acre Exchange Module 348 controls the creation and destruction of unused acres, while allowing the user the ability to transfer paid-for acres between different computers. For example, the user can store unused acres on one computer, develop a map on another computer, and then transfer the unused acres to the computer with the map in order to pay for the creation of a spreadable map.

Subscription Manager 342 provides a user interface for purchasing a map before the map has actually been created. Subscription Manager Module 350 allows the user to purchase a set amount of acres in advance. Once the map has been created, the acres previously purchased can be put towards the payment of the map.

CMS Administrative Tool 344 provides a substitute for the file management performed by Acre Exchange 340. CMS Administrative Tool 344 is a computer interface that allows a user to manage map files of Controller Application Maps 132, which are maps that are paid for and ready to be used by Application Control System 106. Coupon Management System 352 is a software module that works with CMS Administrative Tool 344 to add, delete, and organize map files. Coupon Management System 352 stores information related to the map files in Coupon Database 354.

Once Controller Application Maps 132 have been created, the map file acts as a receipt for payment of the map. If a user decides not to use the map, CMS Administrative Tool 344 can exchange the map file for the purchase of an alternative map. Coupon Management System 352 determines if the new map is for the same field and covers the same area, thus allowing an even exchange. If the new map requires more acres, Coupon Management System 352 can access other map files for additional acres. CMS Administrative Tool 344 gives the user flexibility in the creation and deletion of maps. The user can pay for a map one day and if a week later weather conditions make the map no longer valid, the user is not stuck with a map that can no longer achieve the results desired.

Map Reports Module 346 allows the user to print various sub-maps that are created while generating Controller Application Maps 132. The sub-maps are Geographical Reports 140 and include Field Attribute Maps 242, Agronomic Prescription Maps 248, Demo Applications Maps 252, and Controller Application Maps 132.

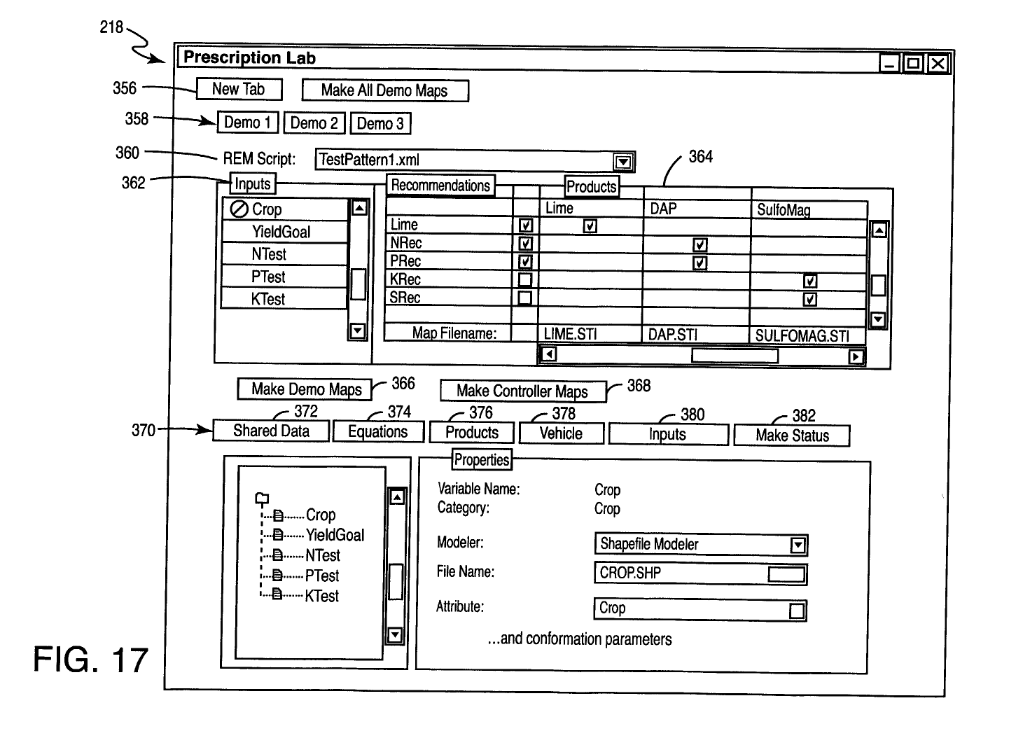

17. Prescription Lab 218 (FIG. 17)

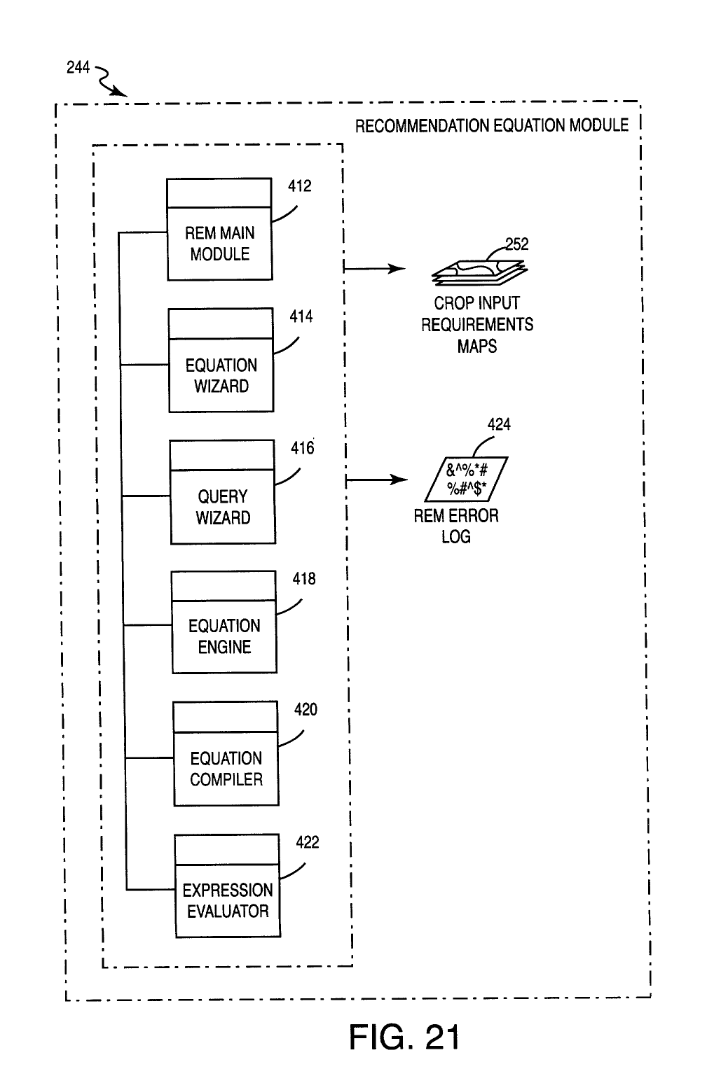

There are three basic steps involved in creating Crop Input Requirement Maps 252. The first step is to input Agronomic Data 118 and convert the data into Field Attribute Maps 250. The second step is to input Recommendation Equations 124. The third step is to create a prescription of crop inputs for specific sections of a field based on Recommendation Equations 124 and Field Attribute Maps 250. The combination of crop inputs for each section of a field results in Crop Input Requirement Maps 252. The first two steps are completed using Prescription Lab 218, PROx 262 and Equation Editor 264, as shown in FIGS. 17-20 and described below. The last step involves REM 244, which is shown and described in FIG. 21.

Prescription Lab 218 is shown in FIG. 17. As described previously, Prescription Lab 218 is the software interface used to develop Field Attribute Maps 250, Crop Input Requirement Maps 252, Demo Application Maps 136, Controller Application Maps 132, and access a number of different software interfaces.

The components of Prescription Lab 218 include New Tab 356, Demo Tabs 358, REM Script 360, Inputs 362, Recommendations & Products 364, Make Demo Maps 366, Make Controller Maps 368, and Software Interface Tabs 370 (specifically, Shared Data Tab 372, Equations Tab 374, Products Tab 376, Vehicle Tab 378, Inputs Tab 380, and “Make” Status Tab 382). A layout of the components of Prescription Lab 218 are shown FIG. 17. While FIG. 17 shows one possible layout, Prescription Lab 218 is not limited to this configuration of components.

As described previously, if a user decides to develop an application map, Mapping Software 100 will take the user to Prescription Lab 218. Prescription Lab 218 is the interface used to input data and access various software modules, such as REM 244 or SBM 246. With respect to the development of Crop Input Requirement Maps 252, Prescription Lab 218 provides the interface for inputting the information needed by REM 244 to create the maps. Crop Input Requirement Maps 252 are not external outputs of Mapping Software 100 and cannot be accessed by a user. Instead, the maps are internal to Mapping Software 100, specifically REM 244, and can only be accessed by software programmers who are familiar with the operation of REM 244. Therefore, Prescription Lab 218 does not include a component or button for creating Crop Input Requirement Maps 252. Crop Input Requirement Maps are automatically created by REM 244 once the information needed by REM 244 has been entered by the user.

As explained previously, Crop Input Requirement Maps 252 provide the prescription or percentage of crop inputs needed for each subsection of a field, such as potassium or phosphorus. Once Crop Input Requirement Maps 252 have been created, the information from Product Information 126 is used by SBM 246 to change the percentages of crop inputs needed into a blend of agricultural products.

Once Prescription Lab 218 is open, the first step is to set up an application plan. An application plan refers to all the information necessary to create the various stages of maps, specifically Field Attribute Maps 250, Crop Input Requirement Maps 252, Demo Applications Maps 134 and Controller Application Maps 132. A user may choose to edit an existing application plan or create a new application plan. New Tab 356 is used to create a new tab for an application plan. Demo Tabs 358 are used to access the various application plans that may be open simultaneously. Once an application plan is open, the user enters the information necessary to create Crop Input Requirement Maps 252.

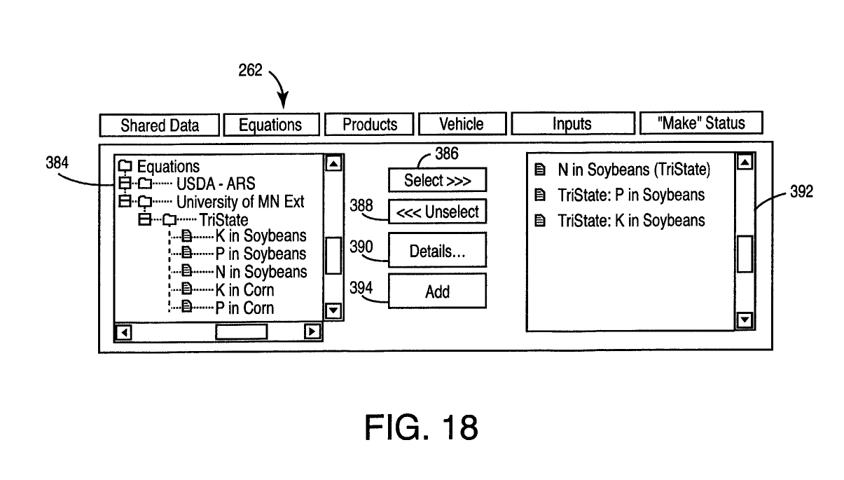

The first step in creating Crop Input Requirement Maps 252 is to input Recommendation Equations 124. Recommendation Equations 124 are selected using REM Script 360. A user can click on the right-hand button of REM Script 360 to view a list of the recommendation equation files stored in Mapping Software 100. Each file may contain one or more recommendation equations to be used in developing Crop Input Requirement Maps 252. If the user does not find a specific equation or wishes to create a new file of equations, the user can access Software Interface Tabs 370, specifically Equations Tab 374. Equations Tab 374 will take the user to an interface for creating a new file containing recommendation equations. Once the file has been created, the user can select the file from the list contained in REM Script 360. The interface and development of custom recommendation equations will be described in more detail with FIG. 18.

The next step in creating Crop Input Requirement Maps 252 is to input Agronomic Data 118. Agronomic Data 118 is collected, formatted and stored using Field Data Collection System 102 and Mapping Software 100, as described above. Agronomic Data 118 is converted from raw information into a spatial map of information, referred to as Field Attribute Maps 252. As described above, the conversion from Agronomic Data 118 to Field Attribute Maps 250 is performed by the various data modelers of Prescription Mapping System 160 and Conformation Module 240. Since Field Attribute Maps 250 are stored in Spatial Data Management System 168, the information is readily available and can easily be accessed by REM 244. Once a file has been selected by REM Script 360, Inputs 362 automatically displays the inputs needed to resolve the equations stored in the file. Prescription Lab 218 informs the user if the required inputs are not available.

Inputs 362 lists the inputs needed to resolve the equations stored in the file of REM Script 360. A slashed-circle is used to indicate to the user that further information is needed for an input. For example, in FIG. 17, a slashed-circle appears to the left of “Crop,” which indicates that additional crop information is needed. At this point, the user can access any information stored in Mapping Software 100 or import the necessary data. The user accesses the information by selecting one of the tabs contained in Software Interface Tabs 370. In this example, the user selects Inputs Tab 380.

Inputs Tab 380 accesses the interface for various data modelers. This interface is shown in the bottom half of FIG. 17, but depending on which tab is selected, a number of different interfaces may be shown instead. The data modeler interface allows the user to input, select or manipulate input information. For example, a user can use one of the modelers contained in Prescription Mapping System 160, such as Nutrient Modeler 226, to update soil information that is out of date. Once all the inputs needed to resolve the equations in the file of REM Script 360 are available, the user can edit the equations selected.

Recommendations & Products 364 gives the user access to the equations and products used in developing an application plan. For example, FIG. 17 shows that the file selected under REM Script 360 contains recommendation equations for Lime, NRec (Nitrogen), PRec (Phosphorus), KRec (Potassium), and SRec (Sulfur). FIG. 17 also shows a check-box to the right of each ingredient. If a user decides not to use one of the equations, such as Potassium and Sulfur in FIG. 17, the user can uncheck the box and the equations for those ingredients are no longer used. When an equation is disabled the row is greyed out. Once REM 244 has the information necessary to develop a prescription of crop inputs, Recommendation Equations 124 and Field Attribute Maps 250 are combined to create Crop Input Requirement Maps 252, which are stored in memory for future access by SBM 246. The operation of REM 244 is explained in further detail under Section 21 below.

Prescription Lab 218 accesses other interfaces beyond equations and inputs. Shared Data Tab 372 connects to an interface that defines field attributes, such as ownership data, geographic data, etc. This information is defined by Field Lab 274, which is part of Planning System 166. Products Tab 376 accesses the interface for PROx 262. This interface allows the user to select or add commercial products to be used in a field. Vehicle Tab 378 is a link to information imported from Vehicle Profile Data 122. Vehicle Profile Data 122 provides the user with information on vehicle performance. “Make” Status Tab 382 provides an interface that shows the status of map completion. The status may include the percentage complete or any errors that occurred while creating the map.

18. PROx 262—Equations (FIG. 18)

The software interface of PROx 262 is shown in FIG. 18. A user can select either the “Equations” tab or the “Products” tab, both are part of PROx 262. The interface accessed by selecting the “Equations” tab is shown in FIG. 18. The “Equations” interface of PROx 262 includes Equations 384, Select 386, Unselect 388, Details 390, Equations Display 392, and Add 394. While the interface of PROx 262 is shown as a stand-alone display, this display would typically be incorporated into Prescription Lab 218, as shown in FIG. 17.

PROx 262 provides an interface that allows a user to create a file containing recommendation equations by either selecting an equation from a list of pre-defined equations or inputting new equations. Equations 384 includes a list of pre-defined recommendation equations. Equation Select 386 allows a user to choose an equation. When a user selects an equation, it is displayed by Equation Display 392. A user can select numerous equations for one file. Equation Unselect 388 is used to remove an equation from the list in Equation Display 392. Equation Details 390 provides the user with more details about the equations. Equation Add 394 allows a user to add a new recommendation equation.

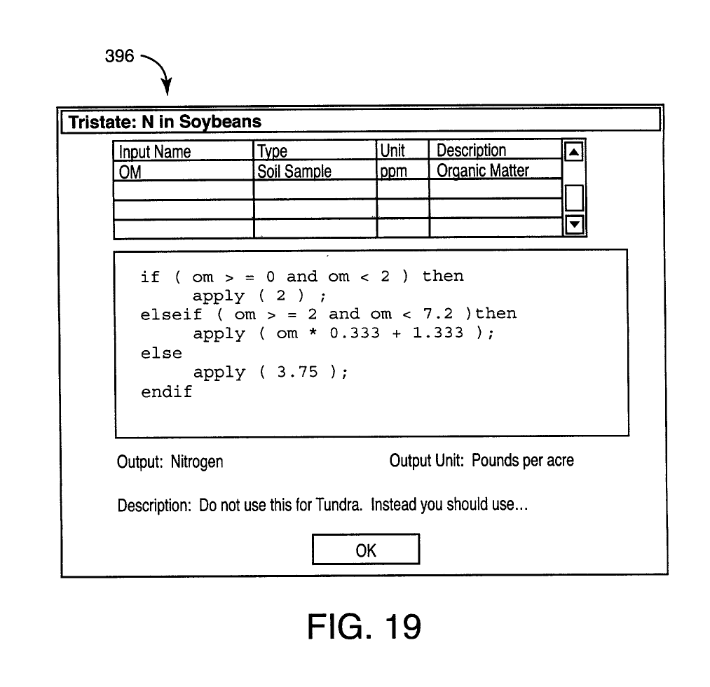

19. Details Display 396 (FIG. 19)

Equation Details Display 396 is shown in FIG. 19. A user access the interface for Equation Details Display 396 by selecting Equation Details 390, as shown in FIG. 18. Equation Details Display 396 is an interface containing an equation or directions on how to calculate the amount of a crop input needed for a specific section of a field. FIG. 19, for example, shows the details for calculating the nitrogen in soybeans based on a formula named TriState. This formula is a pre-defined formula developed by the University of Minnesota Extension Office, as shown in FIG. 18 under Equations 384. Equation Details Display 372 provides the user with additional information to consider in determining which equation or equations are best suited for a particular field.

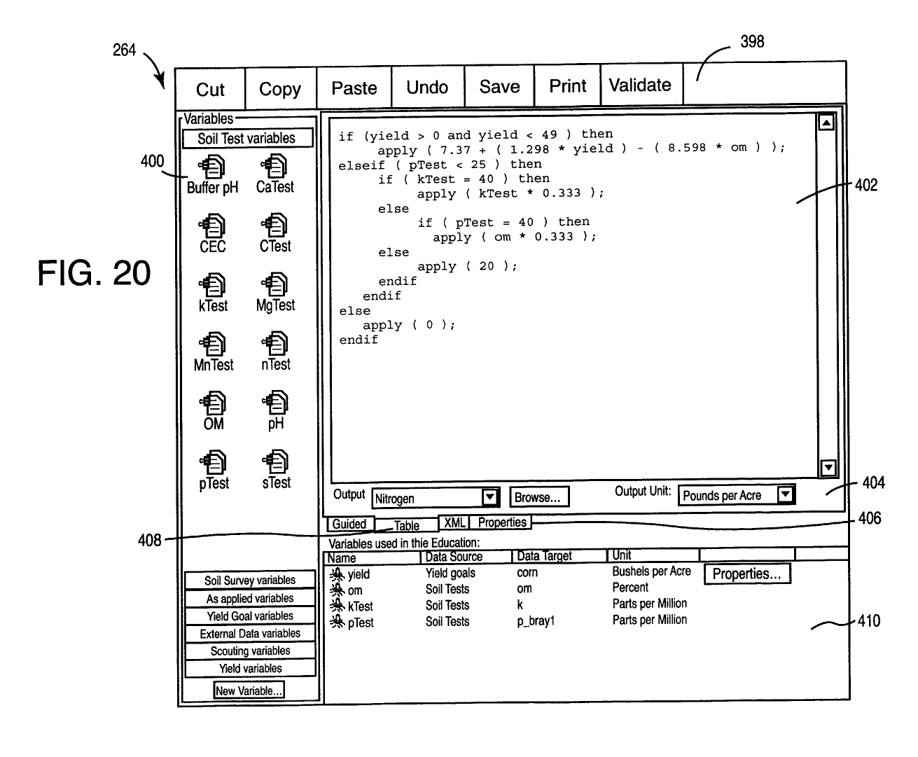

20. Equation Editor 264 (FIG. 20)

Equation Editor 264 is shown in FIG. 20. A user accesses Equation Editor 264 by selecting Equation Add 394, as shown in FIG. 18. Equation Editor 264 includes Toolbar 398, Variables 400, Equation Edit Box 402, Output Properties 404, Equation Tabs 406, Table Tab 408 and Variable Properties 410. Equation Editor 264 is used to create new recommendation equations to add to the list of equations under Equations 384 in FIG. 18. Equation Editor 264 allows a user to edit the logic of an equation and specify various equation properties. FIG. 20 provides an example of an interface for Equation Editor 264, but Equation Editor 264 is not limited to this interface.

Recommendation Equations 124 may be created using an algebraic equation or combination of equations, a script or code of actions based on “if-then-else” commands, or a table describing the relationship between field attributs and crop inputs. Recommendation equations are a function of generalized field attributes. For example, a typical equation might be: nitrogen=2.0*nitrogen 6 yield, which will determine how much nitrogen to spread on a field based on the soil test value for nitrogen measured at a six inch depth and desired yield.

The first method of generating a solution using REM 244 includes algebraic equations or textual scripts. Equation Editor 264 provides the user with the components needed to create an equation. Toolbar 398 gives the user the ability to cut, copy, paste, undo, save, and print the text of the equation. Toolbar 398 also provides the user with the ability to validate an equation, which allows the user to fully parse the syntax of an equation using REM 244.

Variables 400 display all of the stored variable templates from the database. Each template contains a unique set of variables. As shown in FIG. 20, the variable templates include Soil Test, Crop Scouting, Soil Surveys, As-Applied Maps, Yield Maps, Yield Goals, and External Sources. Other templates may be added to the list. To jump between templates, a user selects the page button for that group and the entire page of variables is displayed. In addition, a variable can be added to one of the groups by using the “New Variable” button that is part of Variables 400.

Equation Edit Box 402 is an equation logic editing box. It is an active box that allows the user to enter logic statements that will be analyzed by REM 244. Equation Edit Box 402 color codes language elements to provide visual clues for the user. For example, functions are shown in purple, variables in bold black, comments in green, etc. Equation Edit Box 402 also provides drop down boxes to assist the user in completing equations, such as a list containing “sand, silt, or clay” to help the user define the variable “texture.”

The syntax of each line in Equation Edit Box 402 is analyzed by REM 244 once the insert cursor exits the line. Lines with incorrect or ambiguous syntax are highlighted in red to help the reader troubleshoot the line of code.

Output Properties 404 allow the user to alter the properties of the equation output. This includes selecting a different output product and changing the unit of the output value. As shown in FIG. 20, one box displays the name of the output and another box displays the units of the output.

Equation Tabs 406 provide access to additional interfaces that provide information about the equations, such as equation properties or XML versions of the equation. Table Tab 408 changes the format or interface of Equation Edit Box 402 to a table format for entering product information, as explained in more detail below. Variable Properties 410 displays information about each of the variables used in the equation. It also provides access to a properties dialog that allows the user to fine tune the variable's properties.

The second method of generating solutions using REM 244 is with tables. A user can select Table Tab 408 to change the format of Equation Edit Box 402 to a table format. This allows the user to enter information directly from a table listed on the label of a commercial agricultural product. The tables can be multi-dimensional and either numeric or equation tables. REM 244 converts the information from the product label into an equation. These recommendation equations are then stored in Equation Database 272 and indirectly accessed by REM 244.

Basic operations, such as add, subtract, multiply, and divide, are supported by Equation Editor 264. Standard functions like exponent, cosine, sine, and logarithm are also supported. In addition, control statement structures such as “if-then-else” loops are supported. Equation Editor 264 supports a number of attributes, such as none, slight, moderate, and severe, referred to as enumerated variables. Enumerated variable can be ranked so that the terms can be used as thresholds of prescription application rates. For example, a herbicide rate can be increased if weed pressure is greater than moderate. Overall, the user has great flexibility in describing and formatting the recommendation equations.

21. Recommendation Equation Module (REM) 244 (FIG. 21)

The operation of REM 244 is shown in FIG. 21. The software modules of REM 244 are REM Main Module 412, Equation Wizard 414, Query Wizard 416, Equation Engine 418, Equation Compiler 420, and Expression Evaluator 404. As described above, the inputs to REM 244 are Recommendation Equations 124 and Field Attribute Maps 250. These inputs are indirectly obtained by REM 244 and thus not shown as a direct input in FIG. 21. The outputs of REM 244 are Crop Input Requirement Maps 252 and REM Error Log 424. These outputs are not available to the normal user, but may be accessed internally by other software programs of Mapping Software 100. The outputs may also be accessed by software programmers who understand the operation of REM 244.

REM Main Module 412 contains the main logic for the generation of Crop Input Requirement Maps 252. The user begins the process of creating Crop Input Requirement Maps 252 by selecting a field. Once a field is defined, the user selects a file containing recommendation equations. If the file does not exist, the user is taken to PROx 262, as described above. The user can either create a new file using pre-defined recommendation equations or create a new file with user-defined equations. As previously described, Equation Editor 264 is used to create new equations. At this point, REM Main Module 412 calls Equation Wizard 414 to work with Equation Editor 264 in generating new equations.

Equation Wizard 414 is responsible for checking the syntax of the equations sent to REM 244 from Equation Editor 264. If the equation meets the required syntax, REM Main Module 412 processes the equation using the other software modules of REM 244. If the equation does not fit the proper syntax, Equation Wizard 414 sends the user an error and shows the user where the error occurred. In some situations, Equation Wizard 414 may attempt to correct the problem.

Once a valid set of equations exists, a symbol table containing an entry for each variable referenced in the equations is generated. For each entry into the table, an association is necessary. Associations can be predefined or can vary depending on how the user sets up the equation. If any associations are undefined, the user is taken to Query Wizard 416. Query Wizard 416 helps the user define the variables. Query Wizard 416 shows the user which variables are not defined. Query Wizard 416 also helps the user distinguish between various associations for the same equation, such as one equation using an association for nitrogen at 3 inches and another association of nitrogen at 6 inches.

REM Main Module 412 uses Equation Engine 418, Equation Compiler 420, and Expression Evaluator 422 to process each recommendation equation. Equation Engine 418 substitutes formal parameters with actual data. Equation Engine 418 uses information from Field Attribute Maps 250 as the actual data to substitute for formal parameters. Equation Compiler 420 parses the equations or code and generates the necessary paths of execution. Equation Compiler 420 stores the parsed information in memory to be used every time the code is processed. Expression Evaluator 422 parses each line or expression of the code and determines the precedence of each action, such as processing information in brackets first. Together these software modules generate a prescription of crop inputs for each section of a field. The combination of subsections produces Crop Input Requirement Maps 252.

REM 244 offers many advantages. First, REM 244 is designed to be a stand-alone system that can be used with Mapping Software 100 or incorporated into third-party software. The only requirement in using it with third-party software is that the input data comply with a specified format. Second, REM 244 provides a high-speed map generation process. The stand-alone feature of REM 244 speeds up the data processing and creates a more efficient method of creating application maps. Next, REM 244 provides a flexible language for creating recommendation equations. Equations can contain an unlimited number of nested if-then-else statements. Enumerated variables allow equations to be written using fuzzy terms such as “none, slight, moderate, or severe.” A unique syntax allows a user to use the same information for multiple equations or to use different information, such as soil tests at different levels, with the same equation.

REM 244 allows the user to mix variable rate and constant rate equations. Equations can be created using application tables from agricultural product labels. REM 244 can also handle any number of application scenarios, such as a single-pass operation that applies multiple products or multiple applications that apply a single product with each pass. Overall, REM 244 provides the user with great flexibility with numerous mapping options. If a user doesn't like the results of one mapping situation, REM 244 allows the user to modify the equation, the products, the inputs, etc. to find the right solution.

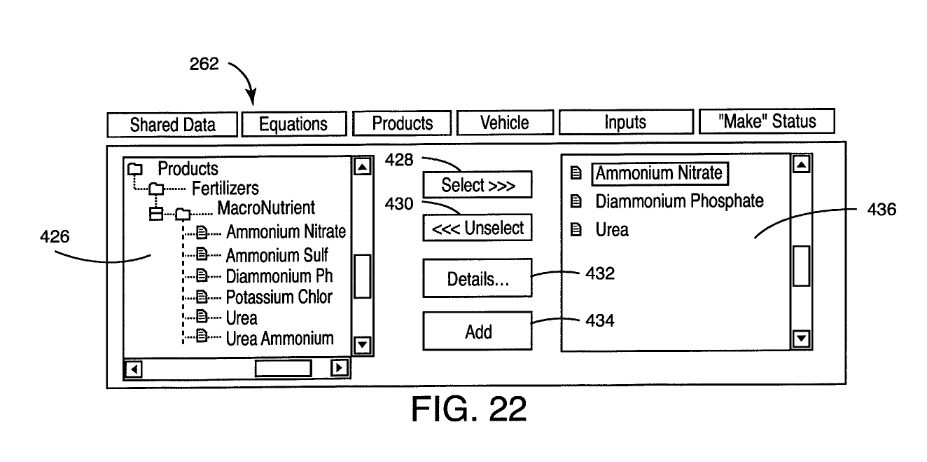

22. PROx 262—Products (FIG. 22)

The software interface of Prescription Lab 218, shown in FIG. 17, is used to create Demo Application Maps 136. By selecting Products Tab 376, the “Products” interface of PROx 262 replaces the data modeler interface shown in the bottom half of the interface of Prescription Lab 218. The “Products” interface of PROx 262 is shown in FIG. 22. The “Products” interface of PROx 262 includes Products 426, Product Select 428, Product Unselect 430, Product Details 432, Product Add 434, and Product Display 436.

PROx 262 allows a user to select or add Product Information 126, which is used by Spatial Blending Module (SBM) 246 to create Demo Application Maps 136. Products 426 displays a list of predefined products that can be used in developing Demo Application Maps 136. Product Select 428 is the button used to select one of the agricultural products. The product is then displayed in Product Display 436. All the agricultural products chosen by the user and displayed in Product Display 436 become the list of products displayed in Recommendations and Products 364. A user can remove products from the list by selecting Product Unselect 430. In addition, details for each agricultural product can be displayed by selecting Product Details 432 and new products can be added to the existing list by selecting Product Add 434.

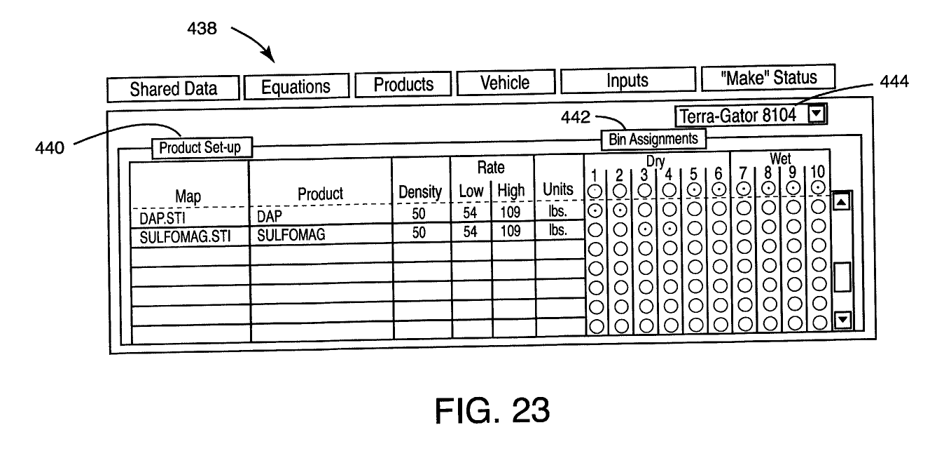

23. Product Details Display 438 (FIG. 23)

Product Details Display 438 is shown in FIG. 23. Product Details Display 438 provides the user with further details for each agricultural product shown in Products 426. The user is taken to the interface for Product Details Display 438 by selecting a product in Products 426 and then selecting Product Details 432, as shown in FIG. 22. Product Details Display 438 includes Product Setup 440, Product Bin Assignment 442, and Vehicle Selection 444.

Product Setup 440 Provides density and rate information for each agricultural product. Product Bin Assignment 442 allows the user to select the bins to use for each product. The type and number of bins available depends on the application vehicle used to apply the products. Vehicle Selection 444 is used to select an application vehicle. Once the application vehicle is selected, the user can select the bins accordingly.

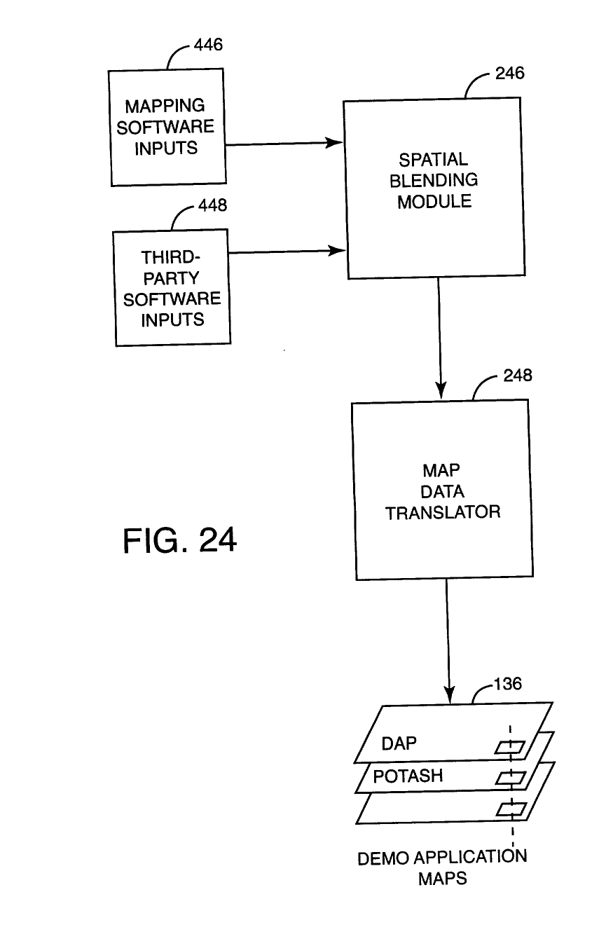

24. Process Flow of Information In and Out of Spatial Blending Module 246 (SBM) (FIG. 24)

The flow of information in and out of Spatial Blending Module (SBM) 246 is shown in FIG. 24. SBM 246 is responsible for finding the proper blend or prescription of commercial agricultural products to apply to a field. The inputs to SBM 246 can either be Mapping Software Inputs 446 or Third-Party Software Inputs 448. Thus, SBM 246 can either be a stand-alone module used to find the optimal blend of agricultural products for a field or can interact with the other modules of Mapping Software 100 to find the blend of products. Once SBM 246 has created a blend of products, the information is sent to Map Data Translator 248, which performs the final steps of creating Demo Application Maps 136 and Controller Application Maps 132.

Information from Mapping Software Inputs 446 is obtained internally from Mapping Software 100 and becomes part of the plan developed by Prescription Mapping System 160. Inputs from Third-Party Software Inputs 448 is required to be in a textual format and is input into SBM 246. Once SBM 246 has processed the inputs, the information is sent to Map Data Translator 248.

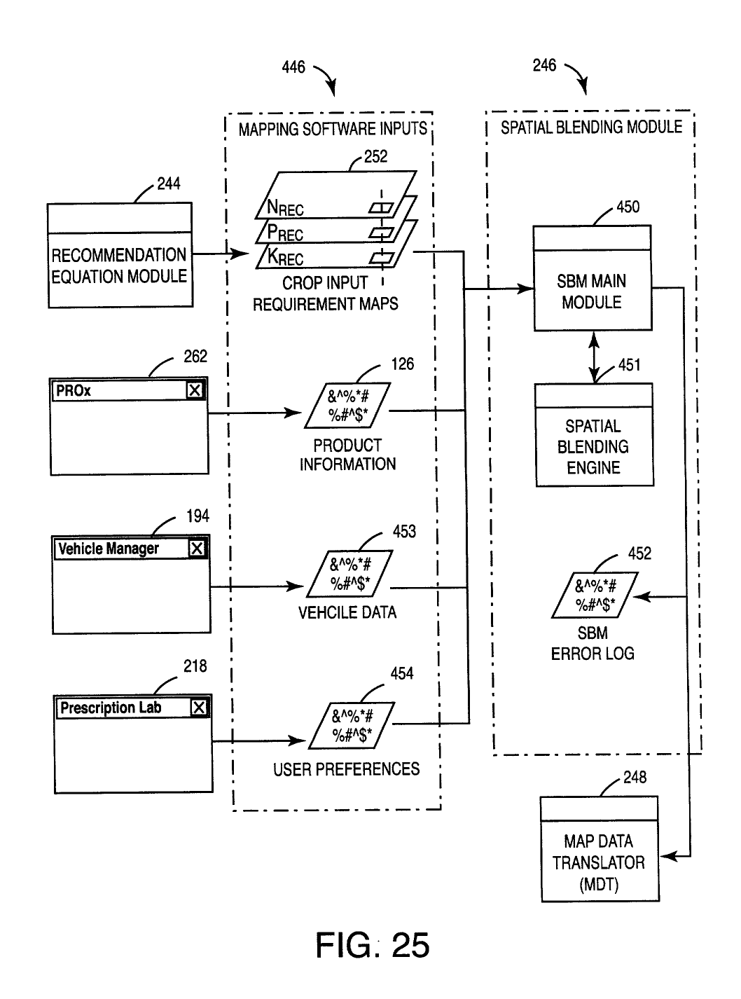

25. Spatial Blending Module (SBM) (FIG. 25)

The operation of Spatial Blending Module (SBM) 246 is shown in FIG. 25. As explained above, the inputs to SBM 246 can either come from Mapping Software Inputs 446 or Third-Party Software Inputs 448. The inputs from Mapping Software Inputs 446 are shown in FIG. 25. The inputs include Crop Input Requirement Maps 252, Product Information 126, Vehicle Data 453, and User Preferences 454. The inputs come from various places in Mapping Software 100. As shown, Crop Input Requirement Maps 252 comes from REM 244, Product Information 126 comes from PROX 262, Vehicle Data 453 comes from Vehicle Manager 194, and User Preferences 454 come from Prescription Lab 218. The internal modules of SBM 246 are SBM Main Module 450 and Spatial Blending Engine 451. SBM 246 also includes SBM Error Log 452. The information from SBM 246 is sent to Map Data Translator 248.

SBM 246 uses a combination or all of the inputs from Mapping Software Inputs 446 to create an optimal blend of agricultural products. The two required inputs are Crop Input Requirement Maps 252 and Product Information 126. SBM 246 attempts to satisfy the prescription of raw ingredients for each cell of a grid by using the crop inputs defined in Product Information 126. Generally, SBM 246 is not able to satisfy the crop input requirements without over-applying or under-applying some or all of the crop inputs. Therefore, the user can provide additional instructions for SBM 246 to use in finding the optimal blend of products.

Prescription Lab 218 provides a software interface where user Preferences 454 are input to Mapping Software 100. User Preferences 100 provide blending instructions for SBM 246. For example, the user can assign a priority to each ingredient defined in Crop Input Requirement Maps 252. Based on this priority, SBM finds a solution where the most important ingredient is satisfied, and then the second most important ingredient, etc. Often, the lower priority ingredients are not completely satisfied. The user may also over-apply or under-apply a crop input containing a specific ingredient. The user can also specify that a certain ingredient be applied exactly. At times the user's instructions may be contradictory, so the user must be able to guide the blending process to achieve the best trade-off between those conflicting constraints.

In addition to specifying instructions for the application of certain crop inputs contained in one or more agriculture products, the user can specify product limits. These limits are in the form of a minimum and/or maximum product application rates. For example, all products do not have the same optimal rate of application. Therefore, the user can guide SBM 246 in finding the most optimal application rate by setting a maximum limit based on one of the agricultural products.

Economic constraints are another type of blending instruction entered by the user with Prescription Lab 218. Economic constraints are cost limitations defined by the user. Certain products are more expensive than others. In addition, some application machines are more expensive to operate than others. SBM 246 takes into account the effects of various economic factors and attempts to create a map that minimizes the application cost.

Vehicle Data 453 provides another type of input to SBM 246 to create a blend of agricultural products. Vehicle Data 453 is responsible for retrieving application vehicle information from Vehicle Manager 194, as shown in FIG. 5 and described above. The information retrieved by Vehicle Manager 194 comes from Vehicle Profile Data 122.

The input data from Vehicle Manager 194 provides SBM 246 with machine constraints. Machine constraints can limit the type and rate of products that can be applied to a field. Thus, if three different products are required for one field, SBM 246 can determine if the machine selected by the user can provide all three products at the proper rate. If the solution is not “good enough”, the user can choose a different application machine or change the blending instructions to find a solution for the machine originally selected by the user.

SBM Main Module 450 is responsible for converting the different input formats of SBM 246 into a standardized format. SBM Main Module 450 also calls Spatial Blending Engine 451 to obtain the necessary prescription of crop inputs for each cell on the map and to format the map before sending it to Map Data Translator 248.

Spatial Blending Engine (SBE) 451 is responsible for implementing the blending process. SBE 451 embodies an algorithm that optimizes the blend of agricultural products according to the user's instructions. The algorithm used by SBE 451 is described in further detail in Section 26 below. The blend of products created by SBM Main Module 450 and SBE 451 is sent to Map Data Translator 248, where it is converted into a format to be used by Application Control System 106.

The errors produced by SBM Main Module 450 are sent to SBM Error Log 452. SBM Error Log 452 is an internal part of SBM 246, but can be viewed by a user. The errors can be informational errors to help a user, system errors designed to help a software developer find problems or a warning that a constrain cannot be met. Information errors include situations where a solution is not available or when necessary information is not available. For example, if potassium is a required ingredient needed for a field but the user has not entered a crop input that contains potassium, a message is sent informing the user that a crop input containing potassium is needed to find a solution.

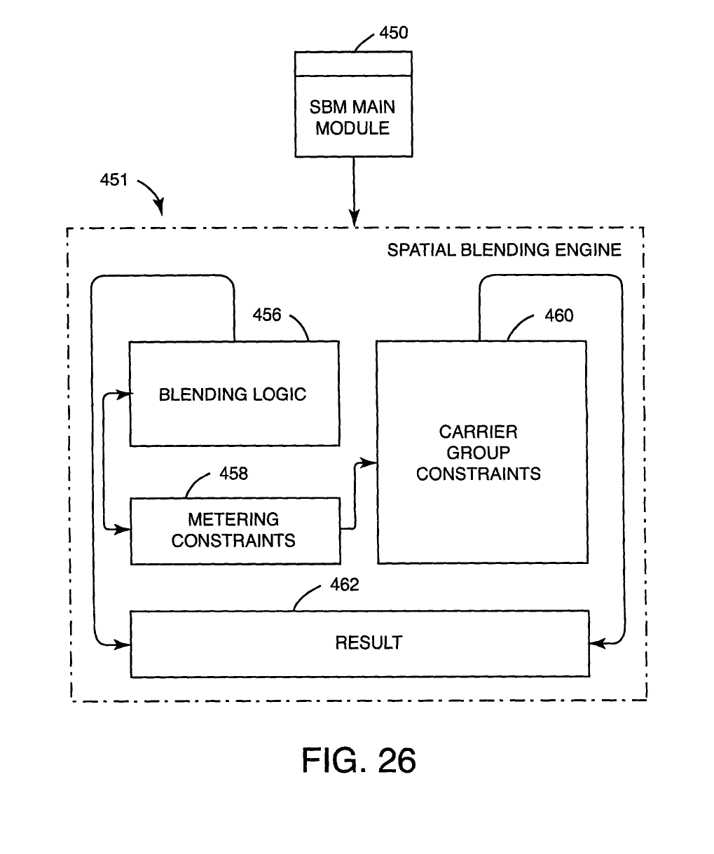

26. Spatial Blending Engine (SBE) 451 (FIG. 26)

The components of Spatial Blending Engine (SBE) 451 are shown in FIG. 26. The various components work together to form an algorithm for creating a prescription or blend of agricultural products. The components of SBE 451 are Blending Logic 456, Metering Constraints 458, Carrier Group Constraints 460, and Result 462. The input to SBE 451 is from SBM Main Module 450.

Blending Logic 456 has three modes of operation. The first mode is to exactly match all the crop input requirements specified by Crop Input Requirement Maps 252. The other two modes are to never-under-apply or never-over-apply specific crop input requirements. Blending Logic 456 sequentially relaxes each crop input requirement based on the priority of each crop input. For example, Blending Logic 456 will attempt to exactly match the requirement for the highest priority ingredient. Once the requirement for the highest priority ingredient has been solved, Blending Logic 456 will attempt to exactly match the requirement for the next highest priority ingredient. If Blending Logic 456 cannot match the requirements for the second ingredient, the requirement will be relaxed to one of the other modes of operation based on the user's instructions.

If the user instructed SBE 451 to never-under-apply the second ingredient, Blending Logic 456 will attempt to match the ingredient requirement by applying a crop input that will never under apply the second ingredient. In other words, the second ingredient applied to the field will either exactly match the requirement or be more than the requirement. Blending Logic 456 treats each ingredient according to its priority and the instructions provided by the user. The user can manipulate the priority and relaxation instruction of each ingredient until the user finds a blend of crop inputs that satisfies all the ingredient requirements. If Blending Logic 456 cannot find a solution based on the user's instructions, Blending Logic 456 sends a message to the user explaining the problem.

In addition to determining an optimal blend of products, Blending Logic 456 determines the optimal rate of application for each crop input. The rate of application of a crop input is often limited to a certain range, such as more than a minimum rate or never over a maximum rate. The user has the ability to set the rate conditions and then Blending Logic 456 finds a solution that satisfies all the rate requirements. If Blending Logic 456 cannot find a solution to the rate requirements, Blending Logic 456 notifies the user.

At a minimum, Blending Logic 456 requires a user to assign a priority and relaxation instruction to each ingredient. In addition, the user must specify minimum and maximum rate requirements for each crop input. These blending instructions provide Blending Logic 456 the information needed to find an optimal blend of products. The user may also apply economic or metering constraints at this point.

Metering Constraints 458 and Carrier Group Constraints 460 can also be used in finding an optimal blend of crop inputs. The user has the option of solving the blend with or without these other constraints. If the user chooses to add vehicle constraints to the blending process, Metering Constraints 458 is accessed by Blending Logic 456. Metering Constraints 458 applies the application constraints for various application machines. A user can optimize the blend against the vehicle constraints of multiple vehicles so that the blend is optimized for a specific type of blend, such as an on-the-fly blend, on-the-ground blend, pre-blend, etc. The different types of blends may involve a multi-pass application or a single-pass application. The blend can also be optimized for multi-pass application with different vehicles for each pass, where one vehicle may apply two different products and another vehicle may apply a third product.

Carrier Group Constraints 460 applies the constraints associated with carrier products. A carrier product is used to apply an agricultural product that cannot be applied individually. For example, a very small quantity of a product may be needed across a field, but no application vehicle can accurately apply such a small amount of the product. A carrier product, such as water, can be used to apply the small quantity of product. Carrier products, in addition to other products, are constrained by minimum or maximum application rates. In addition, the application of a carrier product may be constrained by the application vehicle used to apply the carrier product. Therefore, when a user chooses an agricultural product that requires a carrier, the user must consider both vehicle constraints and carrier constraints. Metering Constraints 458 and Carrier Group Constraints 460 work with Blending Logic 456 to find an optimal blend of products based on the user's instructions for each product and each constraint.

Results 462 contains the various results obtained by the user. The user can run various scenarios of products and instructions and then use Results 462 to compare the different scenarios. Spatial Blending Module 246 does not provide the user with an interface to view the different results, but SBM 246 can access other modules of Mapping Software 100, such as Prescription Lab 218, to allow the user to see and compare the results.

The overall programming routine used SBE 451 is a linear programming algorithm. However, when SBE 451 deals with non-linear constraints, SBE 451 can be switched to a genetic, evolutionary, neural network, or simulated annealing algorithm. This gives SBE 451 greater flexibility to efficiently handle non-linear constraints. At the same time, SBE 451 can process the linear constraints more quickly using the linear algorithm.

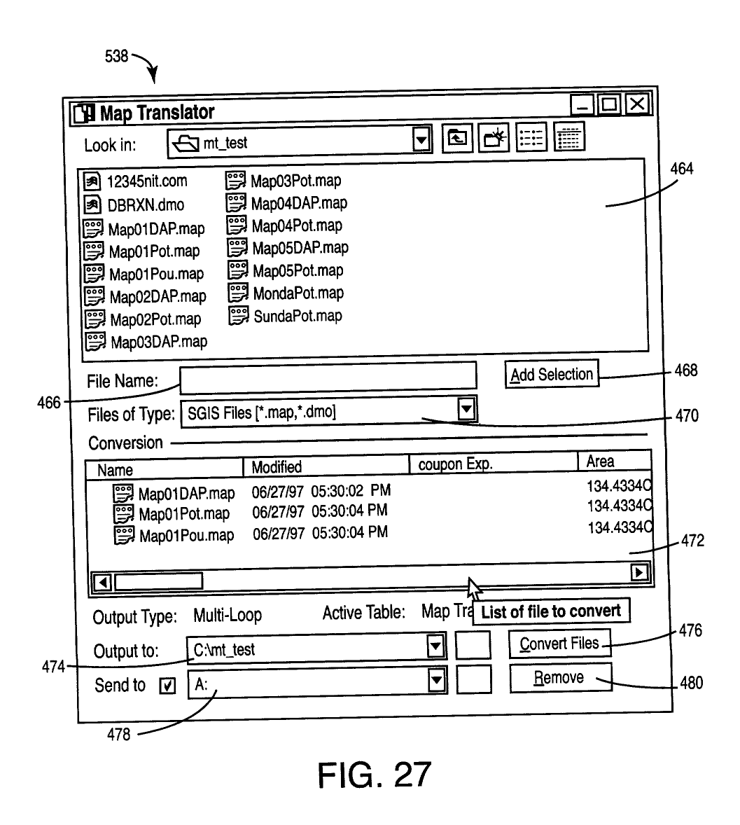

27. Map Translator 338 (FIG. 27)

The software interface for Map Translator 338 is shown in FIG. 27. The components of Map Translator 338 are Map Files 464, File Name 466, Add Selection 468, File Type 470, Map File Conversion 472, Convert Files 474, Remove Files 476, File Output 478, and Send File 480. The user is brought to the interface of Map Translator 338 by selecting Make Demo Maps 366 from Prescription Lab 218, as shown in FIG. 17.

Map Files 464 displays a list of files to convert into Demo Application Maps 136. The file selected by the user is displayed in File Name 466. Add Selection 468 is used to add the file to the list of files in Map File Conversion 472. Once all the conversion files are displayed in Map File Conversion 472, the user selects a location for the output file with File Output 474. Convert Files 474 is then used to convert the files. Convert Files 474 accesses Spatial Blending Module 246, Map Data Translator 248 and the required inputs to create Demo Application Maps 136. A user can also send the file to a disk or other portable storage medium using File Send 478 and Remove 480.

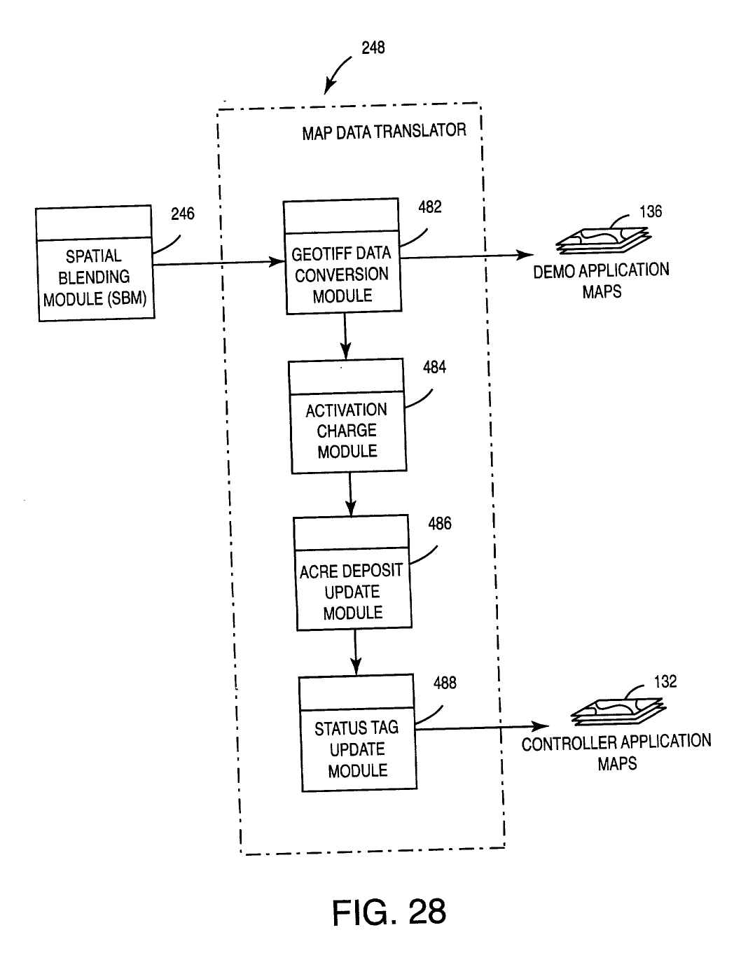

28. Map Data Translator 248 (MDT) (FIG. 28)

The operation of Map Data Translator (MDT) 248 is shown in FIG. 28. The components of MDT 248 are GeoTIFF Data Conversion Module 482, Activation Charge Module 484, Acre Deposit Update Module 486, and Status Tag Update Module 488. The input to MDT 248 is Spatial Blending Module 246. The outputs of MDT 248 are Demo Application Maps 136 and Controller Application Maps 132. MDT 248 is accessed by both Prescription Mapping System 160 and Map Charging System 178.

MDT 248 uses GeoTIFF Data Conversion Module 482 to create Demo Application Maps 136. The remaining modules are used to create Controller Application Maps 132. GeoTIFF Data Conversion Module 482 converts the incoming data into a GeoTIFF format and adds unique data tags. The GeoTIFF format is based on a geographical version of the Tagged Image File Format (TIFF), which is a standard format known in the software development industry. The TIFF specification allows a user to include user-definable tags with the TIFF standard. The geographical version of TIFF (GeoTIFF) is another industry standard developed by Jet Propulsion Lab. This version adds geo-referencing tags to the TIFF specification.

The unique data tags added to the GeoTIFF specification include a checksum used for data integrity, a paid-for-flag, an expiration date, and other miscellaneous tags. Thus, the final format of Demo Application Maps 136 is: TIFF spec+GeoTiff spec+unique data tags=Demo Application Maps. Once GeoTIFF Data Conversion Module 482 has converted the data from Spatial Blending Module 246 into GeoTIFF format for Demo Application Maps 136, the maps are in a format that can be read by Application Control System 106. The maps, however, cannot be used to apply agricultural products until the final steps of MDT 248 are complete. The final steps of MDT 248 ensure that the map has been paid for and that the status tags have been updated.

Activation Charge Module 484 is responsible for determining the charges for creating Controller Application Maps 132. Activation Charge Module 484 compares the charges for the incoming map against incoming “coupon” maps (i.e. already paid for maps) to determine the appropriate charge for Controller Application Maps 132.

Acre Deposit Update Module 486 is responsible for paying for the charges associated with creating Controller Application Maps 132. Acre Deposit Update Module 486 decrements activation charges from the acre deposit account contained in Acre Exchange Module 348.

Status Tag Update Module 488 performs the last step of updating the appropriate status tags. The paid-for tag is set to paid status and the expiration dates and checksum are updated. This last step allows Application Control System 106 to verify the integrity and paid-for status of Controller Application Maps 132. The unique data tags of Controller Application Maps 132 ensure that only paid-for maps can be used and that crop inputs are not misapplied to a field.

Although the present invention has been described with reference to preferred embodiments, workers skilled in the art will recognize that changes may be made in form and detail without departing from the spirit and scope of the invention.

1. A method of comparing applications of agricultural products, the method comprising:
analyzing the potential yield of a first application of agricultural products based on an increase in soil fertility from the application of the products;
analyzing the potential yield of a second application of agricultural products based on an increase in soil fertility from the application of the products; and
comparing the potential yield of the first application with the potential yield of the second application to determine which application results in a higher yield.

2. The method of claim 1 wherein the first application of agricultural products is a site-specific application and the second application of agricultural products is a whole-field application, where the site-specific application varies the application of products across a field and the whole-field application consistently applies the same products across a field.

3. The method of claim 1 wherein the first and second applications of agricultural products are site-specific applications, where site-specific applications vary the application of products across a field.

4. A method of comparing applications of agricultural products, the method comprising:
analyzing the cost savings of a first application of agricultural products based on limiting the application of products in areas with high-quality soil;
analyzing the cost savings of a second application of agricultural products based on limiting the application of products in areas with high-quality soil; and
comparing the cost savings of the first application with the cost savings of the second application to determine which application results in a better cost savings.

5. The method of claim 4 wherein the first application of agricultural products is a site-specific application and the second application of agricultural products is a whole-field application, where the site-specific application varies the application of products across a field and the whole-field application consistently applies the same products across a field.

6. The method of claim 4 wherein the first and second applications of agricultural products are site-specific applications, where site-specific applications vary the application of products across a field.

7. A system for comparing applications of agricultural products, the system comprising:
a first yield analysis system for analyzing the potential yield of a first application of agricultural products based on an increase in soil fertility from application of the products;
a second yield analysis system for analyzing the potential yield of a second application of agricultural products based on an increase in soil fertility from application of the products; and
a yield comparison system for comparing the potential yield of the first application with the potential yield of the second application to determine which application results in a higher yield.

8. The system of claim 7 wherein the first application of agricultural products is a site-specific application and the second application of agricultural products is a whole-field application, where the site-specific application varies the application of products across a field and the whole-field application consistently applies the same products across a field.

9. The system of claim 7 wherein the first and second applications of agricultural products are site-specific applications, where site-specific applications vary the application of products across a field.

10. A system of comparing applications of agricultural products, the system comprising:
a first cost analysis system for analyzing the cost savings of a first application of agricultural products based on limiting the application of products in areas with high-quality soil;
a second cost analysis system for analyzing the cost savings of a second application of agricultural products based on limiting the application of products in areas with high-quality soil; and
a cost comparison system for comparing the cost savings of the first application with the cost savings of the second application to determine which application results in a better cost savings.

11. The system of claim 10 wherein the first application of agricultural products is a site-specific application and the second application of agricultural products is a whole-field application, where the site-specific application varies the application of products across a field and the whole-field application consistently applies the same products across a field.

12. The system of claim 10 wherein the first and second applications of agricultural products are site-specific applications, where site-specific applications vary the application of products across a field.
